(19) United States
(12) Patent Application Publication
(10) Pub. No.: US 2007/0210112 A1
(43) Pub. Date: Sep. 13, 2007

(54) Emptying Device For A Bulk Goods Container And Bulk Goods Container

(75) Inventors: Mario Storci, Greppen (CH); Jean-Marie Cuennet, Dudingen (CH)

Correspondence Address: BIRCH STEWART KOLASCH & BIRCH, PO BOX 747, FALLS CHURCH, VA, 22040-0747, US

(73) Assignee: VISVAL AG, DUDINGEN (CH)

(21) Appl. No.: 10/592,358

(22) PCT Filed: Mar. 14, 2005
(86) PCT No.: PCT/CH05/00153

§ 371 Date: Jan. 30, 2007

(30) Foreign Application Priority Data
Mar. 12, 2004 (EP) 04405150.6

(51) Int. Cl. B65G 69/06

(52) U.S. Cl. 222/195

(57) ABSTRACT

An emptying device (10) which is used to empty bulk goods out of a bulk goods container (50), comprising a base structure (20), a connection part (24) provided with an inlet (26) and a through-flow channel (22) leading to the inlet (26). The bulk goods container (50) is provided with a closure with a connection flange (51,52) which is provided with an outlet (54) for the bulk goods, and a closure element (60) which is used to close and selectively open the closure. The connection part (24) is configured in such a way that the connection flange (51, 52) is tightly joined to the connection part (24). The connection part (24) is also provided with a pneumatic gas outlet (28). A corresponding pneumatic gas inlet (57,58), which can be arranged on an outer side of the connection flange (51,52) can be joined to the pneumatic outlet (28) such that pneumatic gas can flow from the emptying device (10) via the pneumatic gas outlet (28) of the emptying device (10) through the pneumatic gas inlet (57,58) of the bulk goods container (50) inside said bulk goods container (50) in order to loosen up said bulk goods. The emptying device (10) and the bulk goods container (50) enable the bulk goods container (50) to be tightly joined to the emptying device (10) and ensure reliable emptying of bulk goods from the bulk goods container (50).

### TECHNICAL FIELD

The invention relates to an emptying device for emptying bulk goods from a bulk goods container and a bulk goods container and a closure for a bulk goods container.

### PRIOR ART

For emptying and/or discharging bulk goods from bulk goods containers, the bulk goods are discharged through outlets configured in the container walls. To this end, the bulk goods containers are typically attached to an emptying device (also denoted as a discharge device or docking device and/or discharge station or docking station) which is provided with an inlet which discharges into a through-flow channel, through which the bulk goods are able to flow out (also denoted as “to stream”).

In a first type of emptying device, after connecting the bulk goods container, the emptying of the bulk goods is substantially carried out by compressed air being blown into the bulk goods container, which then carries the bulk goods along and, together with the bulk goods, flows through the outlet, out of the bulk goods container and through the inlet into the emptying device. Emptying devices of this type are, for example, disclosed in the publications U.S. Pat. No. 5,474,111 (Degussa), DE 1 257 682 (Schröder) and U.S. Pat. No. 4,790,708 (von Bennigsen-Mackiewicz). For metering or restricting the flow of the bulk goods, this first type of emptying device is typically provided with a metering device comprising check valves and/or shut-off valves and which is arranged in the through-flow channel of the emptying device. This has the result that, after stopping the flow of the bulk goods by means of the metering device, the bulk goods remain stationary in the emptying device upstream of the metering device. These bulk goods frequently have to be subsequently disposed of as waste and additionally may be problematic in the case of toxic bulk goods, with regard to safety during the operation of the emptying device.

A second type of emptying device is configured for emptying bulk goods containers which have a closure which is provided with a connection flange in which the outlet is configured and with a closure member for closing and selectively opening the outlet and/or the closure. This second type of emptying device is equipped with a closure actuating device for actuating the closure of the bulk goods container. After connecting the bulk goods container to the emptying device, the emptying of the bulk goods is effected by the closure of the bulk goods container being opened by means of the closure actuating device, whereupon the bulk goods are able to flow out from the bulk goods container through the outlet. As the bulk goods container itself is already provided with a closure for the bulk goods, a further closure or metering device in the emptying device may frequently be dispensed with. Emptying devices of this second type are, for example, known from the publications EP 0 915 032 (AT Anlagetechnik AG), WO 98/43902 (Matcon) and FR 2 587 780 (Rhone Poulenc). The emptying devices disclosed in the two last-mentioned publications are furthermore each provided with a compressed air cleaning device which makes it possible to clean the emptying device and/or the bulk goods container in the connection region by means of compressed air.

More specifically, emptying devices of the second type allow economical and safe handling of the bulk goods. However, with bulk goods which tend towards clumping, problems may occur during emptying, as the clumping in the bulk goods container hinders or even completely inhibits the emptying process.

### PRESENTATION OF THE INVENTION

It is the object of the invention to provide an emptying device belonging to the aforementioned technical field and a bulk goods container which allow safe operation and reliable emptying and disposing of bulk goods from the bulk goods container.

The object is achieved by the features of the independent claims. According to the invention, for emptying bulk goods from a bulk goods container an emptying device comprises a base structure and a connection part provided with an inlet and a through-flow channel into which the inlet discharges. The bulk goods container has a closure with a connection flange and a closure member. The connection flange is provided with an outlet for bulk goods received in the bulk goods container, through which the bulk goods are able to flow out when the outlet is open. The closure member is configured and arranged for closing and selectively opening the outlet. The connection flange of the bulk goods container may be tightly joined to the connection part of the emptying device such that—when the connection flange is connected to the connection part, i.e. when the bulk goods container and/or its connection flange is connected to the emptying device—when the closure is open, bulk goods are able to flow (also denoted as “to stream”) through the outlet, out of the bulk goods container, through the inlet into the through-flow channel and subsequently through the through-flow channel. The emptying device further comprises a closure actuating device mounted on the base structure or on the connection part and which is configured for actuating the closure (in particular of the closure member) of the bulk goods container. The closure actuating device is provided with a closure actuating element and an adjustment device. The adjustment device is configured and arranged such that, when the closure is connected to the connection part, the closure actuating element may be selectively displaced by means of the adjustment device between a closed position and at least one open position relative to the connection part.

The connection part is further provided with a pneumatic gas outlet which is separated from the inlet. The connection flange of the bulk goods container is further provided with a pneumatic gas inlet corresponding to the pneumatic gas outlet and which is separated from the outlet. Preferably the pneumatic gas inlet of the bulk goods container is arranged on an outer side of the connection flange of the bulk goods container (in this case, outer being understood to refer to the bulk goods container and the outer side of the connection flange forming a part of the outer side of the bulk goods container). The pneumatic gas inlet of the bulk goods container and/or its connection flange may be connected to the pneumatic gas outlet of the connection part of the emptying device, such that pneumatic gas is able to flow from the emptying device through the pneumatic gas outlet of the connection part and the pneumatic gas inlet of the connection flange into the bulk goods container, in order to loosen up the bulk goods received in the bulk goods container and, as a result, to assist the outflow of the bulk goods.

Pneumatic gas is understood to be any gaseous flow medium (gas medium) suitable for pneumatic applications. Pneumatic gas may, for example be air, in particular air which has a higher pressure relative to atmospheric pressure (generally denoted as compressed air). Pneumatic gas may, however, also be nitrogen, inert gas or any other gas or gas mixture suitable for pneumatic applications.

In connection with the present description and the claims, a connection flange of the bulk goods container which may be connected to the connection part of the emptying device, means that the connection flange and the connection part are configured such that they may be attached to one another and/or connected to one another in a bulk goods conveying function. In this connection, the bulk goods containers may be moved or displaced and the emptying station may be stationary in order to allow the connection. However, in order to allow the connection, the bulk goods container may also be stationary and the emptying station may be movable or displaceable or both the bulk goods container and the emptying station may be movable or displaceable. Similarly, a pneumatic gas inlet of the bulk goods container (and/or its connection flange) which may be connected to the pneumatic gas outlet of the emptying device (and/or its connection part), means that the pneumatic gas inlet and the pneumatic gas outlet may be joined to one another and/or connected to one another in a pneumatic gas conveying function, the bulk goods container and/or the emptying device in turn may be movable and/or displaceable in order to allow the connection.

The base structure may be configured as a framework or as a housing of the emptying device. The connection part may be configured as an integral part of the base structure. The through-flow channel may also be configured as an integral part of the base structure. It may, however, also be configured in a separate component which is arranged on the base structure of the emptying device.

The bulk goods container may have single-layer or multi-layer flexible container walls and, for example, be configured as a bag or as a large container (also denoted as a “big bag” or “bulk bag”). The bulk goods container may, however, also comprise rigid and/or combined container walls and, for example, be configured as a drum or container.

Opened or open outlet is understood to be the outlet when the closure is opened and/or open. The closure is then in an open position.

The closure actuating device may be mounted directly on the connection part of the emptying device. The closure actuating device may, however, also be mounted on the base structure of the emptying device.

The closure member may be a rigid body (i.e. a closure body) and the closure actuating device may be configured for selectively opening and then closing the closure, in order to allow a discharge of bulk goods from the bulk goods container which may be metered. To this end, the closure member, for example by means of the closure actuating element, which drives the closure member, may selectively be moved away from the outlet and again towards the outlet, the closure actuating element, in turn, being driven and adjusted by the adjustment device of the closure actuating device. The closure body made from a rigid material (for example metal or plastics) may in particular be of conical configuration, which has proved to be particularly advantageous for metered emptying of bulk goods.

The closure member may, however, also be a perforable part of the container wall, a perforable film or another perforable closure element. A closure provided with such a closure member may be opened by the closure member being perforated by means of the closure actuating element driven by the adjustment device. In this case the closure is provided merely for a single opening, i.e. it is a disposable closure.

The closure member, in particular in the case of a closure member configured as a rigid body, may be arranged in an interior of the bulk goods container provided for receiving the bulk goods, it being able, in particular in its closed position, to form a part of the container wall of the bulk goods container.

According to the invention, in the case of an emptying device of the second type (i.e. an emptying device with a closure actuating device for actuating the closure of the bulk goods container) pneumatic gas is supplied through the pneumatic gas outlet of the emptying device and the pneumatic gas inlet of the bulk goods container. For joining the pneumatic gas inlet of the bulk goods container to the pneumatic gas outlet of the emptying device, known pneumatic couplings may be used, couplings which may be actuated manually and/or automatically being possible. The closure of the bulk goods container which may be actuated by means of the closure actuating device of the emptying device firstly ensures a secure and economical operation when emptying bulk goods from the bulk goods container. Secondly, the pneumatic gas supply through the pneumatic gas outlet of the emptying device and the pneumatic gas inlet of the bulk goods container creates the possibility of loosening, by means of pneumatic gas, possible clumped bulk goods in the bulk goods container or bulk goods bridges, which have formed in the bulk goods, for example during storage or transportation. Such a loosening process is also denoted as fluidizing the bulk goods. By the possibility of fluidizing the bulk goods by means of blasts of pneumatic gas, in particular in the case of bulk goods which tend towards clumping or bridge formation, it is possible for the risk of inhibiting the emptying process to be substantially prevented and thus the reliability of the emptying process to be improved.

As the pneumatic gas is supplied via a separate flow path separated from the bulk goods flow (namely through the pneumatic gas outlet separated from the inlet of the emptying device and the pneumatic gas inlet separated from the outlet of the bulk goods container) the prevention of the outflow of the bulk goods and/or the actuation of the closure of the bulk goods container by means of the closure actuating device of the emptying device is avoided. The pneumatic gas outlet and the inlet of the emptying device may be arranged spaced apart from one another (i.e. distanced from one another), in this case being spaced apart from one another according to the pneumatic inlet and the outlet of the bulk goods container. The distance between the pneumatic gas outlet and the inlet of the emptying device (and accordingly the distance between the pneumatic gas inlet and the outlet of the connection flange) may be comparatively small, so that the pneumatic gas outlet and the emptying station, for example, are only separated from one another by an partition wall. A short distance allows a space-saving construction of the connection part and the connection flange.

Additionally, by blowing-in pneumatic gas the bulk goods container may be completely emptied and substantially without residue, which was generally not possible in previously known emptying devices of the second type, in particular with the use of bulk goods containers with flexible container walls (for example bags).

The emptying device may further comprise a control unit for controlling the pneumatic gas supply to the pneumatic gas outlet, so that the pneumatic gas controlled by means of this control unit may be blown into the bulk goods container. The control unit may be configured to control the pneumatic gas supply according to the bulk goods material, the level in the bulk goods container and/or the evacuation performance of an evacuation device connected to the through-flow channel.

As the bulk goods container is provided with a connection flange specifically corresponding to the connection part of the emptying device, a tighter join of the bulk goods container to the emptying device is ensured.

As a result, bulk goods are prevented from flowing past the through-flow channel through the outlet and being lost.

An arrangement of the pneumatic gas inlet on an outer side of the bulk goods container and/or its connection flange, moreover, proves advantageous, as thereby a contamination of the pneumatic gas outlet of the emptying device and the entire connection part of the emptying device by the bulk goods may be substantially avoided. This advantage is, in particular, significant in the case of bulk goods, for which increased requirements with regard to cleanliness (for example with medicines) or safety (with toxic bulk goods) have to be observed.

The pneumatic gas outlet on the connection part of the emptying device may further advantageously be used for additional cleaning of the connection part of the emptying device and/or the closure of the bulk goods container. After the completion of the emptying process and, in particular even after detaching the connection flange from the connection part, pneumatic gas may be blown again through the pneumatic gas outlet in order to blow away bulk goods still possibly present on the connection part and/or on the connection flange by means of the pneumatic gas flow thus produced. If an evacuation device is attached to the through-flow channel, the bulk goods which have been blown away may be similarly sucked up through the inlet and the through-flow channel by means of the evacuation device.

For the purpose of cleaning the connection part, the connection flange and/or a lower front face of the closure member—alternatively or to complement the pneumatic gas outlet of the connection part—the closure actuating element and/or the adjustment device of the closure actuating element may also be provided with pneumatic gas outlets or inlets. The pneumatic gas (in particular air) may be blown out or sucked in therethrough, in order to blow away and/or suck up bulk goods and/or other contaminants from the connection part, from the connection flange and/or from the lower front face of the closure member.

In the case of a bulk goods container with flexible container walls (for example a bulk goods container in the form of a bag) by means of the closure actuating device a further advantage may be achieved. The cover of the bulk goods container may then at least in a late phase of the emptying process be supported by the closure actuating element pushed upwardly by means of the adjustment device (for example into an open position), in order to prevent that—when the bulk goods container is almost empty—the flexible bulk goods container cover rests on the base of the bulk goods container and/or on the outlet and, as a result, prevents complete emptying the bulk goods container. In the case of a closure member which is a closure body made from a rigid material, the closure actuating element may support this closure body. The cover of the almost empty bulk goods container may than rest on the closure body and be supported thereby, which in turn is supported by the closure actuating element, so that the cover is, in turn, indirectly supported by the closure actuating element. In the case of a closure member, which merely consists of a film which may be used once, the bulk goods container cover may also be supported directly by means of the closure actuating element. By the direct or indirect support of the bulk goods container cover by means of the closure actuating element, even in the case of a bulk goods container provided with flexible container walls and which during the emptying process is not suspended anywhere, the bulk goods container is completely emptied without residue.

According to a preferred alternative to a connection part configured as an integral part of the base structure, the connection part provided with a pneumatic gas outlet is configured as a component of an assembly which may be fitted or is fitted to the base structure of the emptying device. When the emptying device is ready for operation, this assembly is fixedly fitted to the base structure and/or connected thereto. By means of such an assembly it is possible to retrofit an existing emptying device, which is not provided with a pneumatic gas outlet, in a simple and cost-effective manner with a pneumatic gas outlet.

According to a preferred embodiment of the invention, the connection part provided with the inlet and the pneumatic gas outlet is configured as a first structural unit on the emptying device side of a common coupling device for the selectively repeatedly releasable connection (i.e. the selectively repeatedly releasable coupling) of both the connection flange to the connection part and also the pneumatic gas inlet to the pneumatic gas outlet. The coupling device comprises a second, structural unit on the bulk goods container side which is formed by the connection flange. The first and second structural units are able to be coupled and or connected to one another in a single coupling process in order to connect and/or couple the connection flange of the bulk goods container to the connection part of the emptying device and the pneumatic inlet of the bulk goods container to the pneumatic gas outlet of the emptying device.

The coupling device is preferably configured such that it may be automatically actuated. Additionally, the coupling device may be actuated mechanically, pneumatically or hydraulically, in order to carry out the coupling process. As a result, it is possible to connect automatically the bulk goods container to the emptying station without an operator having to carry out any manipulation by hand in the region of the bulk goods container. This is particularly advantageous in the case of toxic bulk goods.

The coupling device is preferably configured for the selectively repeatedly releasable connection and/or coupling of the two structural units to one another, the coupling device, for example, able to be configured as a so-called bayonet coupling. On the one hand, an emptying path or discharge path for emptying (also denoted as discharging) the bulk goods from the bulk goods container and on the other hand a pneumatic gas line for supplying the bulk goods container with pneumatic gas is achieved by means of this common coupling device. The same structural unit thus serves both for coupling the pneumatic gas inlet of the bulk goods container to the pneumatic gas outlet of the emptying device and also for coupling the connection flange of the bulk goods container to the connection part of the emptying device, such that bulk goods flow through the outlet from the bulk goods container and through the inlet into the through-flow channel of the emptying device.

As an alternative to a common coupling, however, separate couplings may also be provided to provide a bulk goods discharge path from the bulk goods container to the emptying device and the creation of a pneumatic gas line from the emptying device to the bulk goods container.

Preferably in the case of a common coupling both the inlet and the pneumatic gas outlet have one respective orifice with a planar edge in one and the same outer side of the connection part, the edge of the orifice of the inlet and the edge of the orifice of the pneumatic gas outlet being arranged coplanar to one another. Accordingly, in this case the outlet and the pneumatic gas inlet have in one and the same outer side of the connection flange one respective orifice with a planar edge, the edge of the orifice of the outlet and the edge of the orifice of the pneumatic gas inlet in turn being arranged coplanar to one another. As a result, a particularly simple coupling process for coupling the connection flange to the connection part is made possible.

Advantageously, the pneumatic gas outlet is configured in an outer side of the connection part of the emptying device as an at least partially outwardly open channel, which comprises at least one channel wall, which simultaneously is configured also as a channel wall of the through-flow channel. As a result, a particularly simple construction of the pneumatic gas outlet and the through-flow channel are achieved. The channel wall common to the pneumatic gas outlet and the through-flow channel may on one wall side define the channel-shaped pneumatic gas outlet and on the other wall side define the through-flow channel and/or its inlet. Preferably, the pneumatic gas outlet and the bulk goods inlet are configured and arranged such that the pneumatic gas outlet channel configured in the outer side of the connection part partially or even completely surrounds the bulk goods inlet in this outer side. In this connection, the inlet may be circular and the pneumatic gas outlet may be configured as an annular channel (i.e. as a ring channel), the two being arranged concentrically to one another in the outer side of the connection part.

However, other variants are also possible in which the pneumatic gas outlet and the inlet in the through-flow channel are of different design and/or are arranged at positions of the connection part of the emptying device which are further removed from one another.

Preferably the pneumatic gas inlet of a bulk goods container according to the invention is sealed against the interior of the bulk goods container by a non-return valve which allows a flow of fluid through the pneumatic gas inlet in the direction of the bulk goods container interior, but prevents a flow of fluid in the opposite direction out of the bulk goods interior through the pneumatic gas inlet. By means of the non-return valve, bulk goods are prevented from flowing out of the bulk goods container through the pneumatic gas inlet.

As an alternative to a non-return valve, a filter and/or a smaller cross-section of the pneumatic gas inlet and/or a porous membrane may also be provided, in order to allow pneumatic gas to flow in through the pneumatic gas inlet into the bulk goods container, but to prevent bulk goods from flowing out in the opposite direction. In this variant, the pneumatic gas may in principle flow in both directions through the pneumatic gas inlet. A corresponding closure may therefore not be used simply for emptying the bulk goods container but it may also be used for filling the bulk goods container. In this connection, for the filling process, the bulk goods together with pneumatic gas may flow through the bulk goods outlet configured in the connection flange of the closure into the bulk goods container. The pneumatic gas may then flow from the bulk goods container through the pneumatic gas inlet and again out of the bulk goods container, whilst the bulk goods remain in the bulk goods container.

In the case of a pneumatic gas inlet sealed by a non-return valve, the non-return valve may comprise a valve shut-off body made from a resilient material and which simultaneously acts as a return spring of the non-return valve. If the pneumatic gas inlet comprises a plurality of pneumatic gas inlet orifices discharging into the interior of the bulk goods container and which are sealed by a corresponding number of non-return valves corresponding to the number of pneumatic gas inlet orifices, a single common valve shut-off body made of resilient material may be provided which acts both as a shut-off body and a return spring for all these non-return valves. As a result, a particularly simple and cost-effective construction of the bulk goods container is possible.

The valve shut-off body acting simultaneously as a return spring, is preferably configured and at least partially arranged in the interior of the bulk goods container such that it may be stimulated to oscillate by pneumatic gas which flows into the interior of the bulk goods container through the pneumatic gas inlet. The oscillations are then transmitted to the bulk goods received in the interior and produce a further loosening up of the bulk goods. Such a valve shut-off body may in particular be configured as a planar or pointed lip which is attached to the connection flange or is an integral part of the connection flange and completely bridges a through-passage of the pneumatic gas inlet discharging into the bulk goods container interior. If no pneumatic gas flows through the through-passage, the lip (also denoted as non-return sealing lip) is stretched against the orifice by elastic force which is produced by the resilient material of the lip, so that said orifice is tightly sealed by the lip. If, however, pneumatic gas which is pressurised by overpressure, is delivered into the through-passage of the pneumatic gas inlet, then the pneumatic gas may lift up the non-return sealing lip from the orifice, due to its overpressure against the elastic force of the lip, so that pneumatic gas may flow through the through-passage into the bulk goods container interior. In this connection, the non-return sealing lip is stimulated to oscillate (also denoted as fluttering). The oscillations are transmitted to bulk goods received in the container interior, and which bear against the sealing lip. By means of the oscillations the bulk goods are loosened up which leads to a further improvement of the emptying process.

A bulk goods container according to a further preferred embodiment of the invention is characterised in that a substantial portion of the container wall is made from a flexible material so that the bulk goods container is substantially a bag or a so-called “big bag”. The connection flange of the closure of this bag-like bulk goods container is, however, made from a rigid material (for example metal or plastics). In this connection flange at least one first through-passage for bulk goods is configured, which serves as an outlet or as part of the outlet for the bulk goods received in the bulk goods container. The bulk goods outlet may also comprise a plurality of through-passages configured in the connection flange. Moreover, in the connection flange at least one further through-passage is configured for pneumatic gas which serves as a pneumatic gas inlet or as part of the pneumatic gas inlet. The pneumatic gas inlet may also comprise a plurality of through-passages configured in the connection flange. The connection flange made from a rigid material allows a simple and tight join of the bulk goods container to the emptying device itself, in the case of a bulk goods container configured as a bag.

For connecting the flexible container wall to the connection flange, the single-layered or multi-layered container wall may be clamped between two parts of the connection flange and may be fastened merely by means of the force on the connection flange produced by the clamping. As a result, the possibility arises for reusing the connection flange, as the connection flange may be easily removed from a used and no longer usable container wall (for example in the form of a bag) and a new container inserted into the container wall. Such a two-part or multi-part closure may be configured, in particular, as an exchangeable unit for multiple use for different bulk goods containers which are of identical or different configuration. It is clear that a closure configured as an exchangeable unit, irrespective of whether it now additionally has a further separate pneumatic gas inlet in addition to an outlet for the bulk goods or not, may advantageously be used in connection with bulk goods containers of the aforementioned type.

As an alternative and/or as a complement to the clamping, the container wall may however also be bonded to the connection flange by means of an adhesive, in particular in the case of a container wall made from paper or cardboard. The container wall may, however, also be connected to the connection flange by welding, in the case of a container wall made from a plastics film, in particular also by ultrasonic welding.

According to a further preferred variant, the single-layered or multi-layered flexible part of the container wall is provided with a hole which forms a common through-passage for bulk goods and pneumatic gas. The edge of this hole forms a closed peripheral line and may in particular, for example, be of circular configuration. The container wall is connected along the hole edge to the connection flange in a manner which is sealed against pneumatic gas and bulk goods. In this connection, the outlet configured in the connection flange is arranged in the region of the hole. Additionally, a channel in the connection flange leading from the pneumatic gas inlet into the container interior is configured such that it leads from the pneumatic gas inlet through the hole, past the hole edge and into the interior of the bulk goods container. As a result, the possibility for using a flexible container wall is created which in the region of the connection flange has merely one individual hole, the bulk goods container and/or its connection flange nevertheless comprising at least one pneumatic gas inlet and an outlet which are separated from one another.

According to a further advantageous aspect of the invention, an emptying device for emptying bulk goods from a bulk goods container has a base structure, a connection part provided with an inlet and a through-flow channel into which the inlet discharges. The bulk goods container has a closure with a connection flange and a closure member. The connection flange is provided with an outlet for bulk goods received in the bulk goods container and through which the bulk goods may flow when the outlet is open. The closure member is configured and arranged for closing and selectively opening the outlet. The connection flange of the bulk goods container may be tightly joined to the connection part of the emptying device, such that—when the bulk goods container and/or its connection flange is/are connected to the emptying device—when the closure is opened, bulk goods are able to flow through the outlet out of the bulk goods container through the inlet into the through-flow channel and subsequently through the through-flow channel.

The emptying device further comprises a closure actuating device mounted on the base structure or on the connection part, which is configured to actuate the closure of the bulk goods container. The closure actuating device is provided with a closure actuating element and an adjustment device. The adjustment device is configured and arranged such that when the closure is connected to the connection part, the closure actuating element may be selectively displaced by means of the adjustment device between a closed position and at least one open position relative to the connection part. The adjustment device comprises a piston-cylinder arrangement with a piston mounted on the base structure or on the connection part and at least one cylinder in which the piston is received such that the cylinder may be displaced relative to the piston (and thus relative to the base structure and/or the connection part on which the piston is mounted) in the direction of the cylinder axis. The at least one cylinder is coupled to the closure actuating element, so that said closure actuating element may be driven by means of the piston-cylinder arrangement in order to displace it substantially linearly relative to the connection part. The closure actuating element in turn is able to be coupled to the closure member when the bulk goods container is connected to the connection part of the emptying device such that the closure member may be driven by means of the piston-cylinder arrangement. On the whole, when the closure actuating element is coupled to the closure member, an actuation of the closure member is produced by the drive of the closure actuating element by means of the piston-cylinder arrangement. This aspect of the invention also proves advantageous for fluidising of the bulk goods in the bulk goods container without the provision of a pneumatic gas supply.

In contrast to the emptying device known from EP 0 915 032, according to the invention the piston is mounted in a stationary manner on the emptying device, whilst the cylinder may be displaceably coupled relative to the base structure to the closure member of the bulk goods container closure. When flowing out of the bulk goods container, therefore, the bulk goods flow in the direction from the cylinder to the piston, past the piston-cylinder arrangement, not in the direction from the piston to the cylinder as in the emptying device known from EP 0 915 032. This arrangement according to the invention, leads to less contamination of the piston-cylinder arrangement in the region of the position where the piston projects from the cylinder. As a result, the possibility arises to dispense with an additional shielding of the piston-cylinder arrangement, and more specifically even when the piston-cylinder arrangement is completely arranged in the through-flow channel of the emptying device.

The closure actuating device of the emptying device according to this aspect of the invention is for selectively opening the closure when the bulk goods container is connected to the emptying device. The closure actuating device and/or its piston may be mounted directly on the connection part provided with the inlet. It may, however, also be mounted on the base structure of the emptying device configured as a housing part or frame part.

Preferably the piston-cylinder arrangement may be actuated pneumatically. The risk of contamination of the bulk goods when emptying is lower in the case of a pneumatically actuatable piston-cylinder arrangement than in the case of a hydraulically actuatable piston-cylinder arrangement. In principle, however, for specific uses in which not particularly high requirements relative to the cleanliness of the bulk goods are to be observed, a hydraulic actuation of the piston-cylinder arrangement according to the invention is also possible.

The piston-cylinder arrangement according to the invention may merely comprise a single cylinder which may be displaced relative to the piston. As an alternative thereto, the piston-cylinder arrangement may also however comprise a plurality of cylinder parts which are telescopically displaceable in one another. As a result, longer displacement movements are made possible. Such piston-cylinder arrangements with a piston and a plurality of cylinder parts which are displaceable telescopically in one another are known from lifting devices for tipping out tiltable containers of construction vehicles.

According to a further advantageous aspect of the invention an emptying device for emptying bulk goods from a bulk goods container has a base structure, a connection part provided with an inlet and a through-flow channel into which the inlet discharges. The bulk goods container has a closure with a connection flange and a closure member. The connection flange is provided with an outlet for bulk goods received in the bulk goods container, through which the bulk goods are able to flow when the outlet is open. The closure member is configured and arranged for closing and selectively opening the outlet. The emptying device comprises a closure actuating device mounted on the base structure or on the connection part which is configured for actuation of the closure (and/or the closure member) of the bulk goods container. The connection flange of the bulk goods container may be tightly joined to the connection part of the emptying device, such that—when the bulk goods container and/or its connection flange is connected to the emptying device—when the closure is opened, bulk goods are able to flow through the outlet from the bulk goods container, through the inlet into the through-flow channel and subsequently through the through-flow channel.

A substantial portion of the container wall of the bulk goods container is made from a flexible material, so that the bulk goods container is substantially a bag or a so-called “big bag”. The connection flange of the closure of this bag-like bulk goods container is, however, made from a rigid material (for example metal or plastics). In this connection flange at least one through-passage for bulk goods is configured which serves as an outlet or as part of the outlet for the bulk goods received in the bulk goods container. The closure further comprises a covering member, which, when the bulk goods container is not joined to the emptying device, is arranged on the connection flange, such that it covers the outlet on the outer side of the bulk goods container, the covering member being able to be configured as an integral part of the portion of the container wall made from the flexible material.

The connection part of the emptying device is further provided with a blade unit which is configured and arranged on the connection part such that it is able to cut off the covering member from the connection flange when the connection flange is or has been connected to the connection part.

As a whole, the possibility is created of using a flexible container wall which is completely intact before connecting the bulk goods container to the emptying device in the region of the connection flange (i.e. without any perforations which are permeable to bulk goods) and is completely sealed against bulk goods. This proves to be particularly advantageous in the case of bulk goods for which increased requirements relative to cleanliness (for example with medicines) or safety (with toxic bulk goods) have to be observed. The connection flange is, in this case, preferably made up of at least two parts, a flange part in which the outlet is configured, being arranged on the inside of the container wall and a further flange part being arranged on the outer side of the container wall. The container wall is then clamped between said at least two flange parts and thereby connected to the connection flange. Before connecting the bulk goods container to the emptying device, the outlet on the outer side is covered by the flexible part of the container wall which penetrates and holds together the entire region of the connection flange and its periphery. When the bulk goods container is connected to the emptying device, or after this connection, the cover in front of the outlet formed by the flexible parts of the container wall may then be cut off by means of the blade unit, whereupon the closure of the bulk goods container may be opened by means of the closure actuating device of the emptying device.

It is clear that this aspect of the invention does not necessarily have to be used in connection with the provision of a pneumatic gas supply for fluidising the bulk goods in the bulk goods container or with a piston-cylinder arrangement for driving a closure actuating element.

The blade unit is preferably configured and arranged on the connection part such that it may be actuated completely automatically, in order to cut off the cover from the connection flange. As a result, the possibility arises for a completely automatic connection of the bulk goods container to the emptying device which is particularly advantageous in the case of toxic bulk goods.

The blade unit may, for example, be actuated pneumatically and contain a round blade which—when the bulk goods container is arranged in a position bearing with its connection flange on the connection part—is pneumatically driven against the connection flange and cuts off or stamps out a round surface area corresponding to the round blade shape from the flexible part of the container wall, in order to remove the cover, which is formed by the flexible part of the container wall, from the outlet.

It is further preferable to provide the closure actuating device with a closure actuating element and an adjustment device, the adjustment device being configured and arranged such that when the closure is connected to the connection part, the closure actuating element may be selectively displaced relative to the connection part by means of the adjustment device between a closed position, a cut open position and at least one open position.

According to a further advantageous aspect of the invention, an emptying device for emptying bulk goods from a bulk goods container comprises a base structure, a connection part provided with an inlet and a through-flow channel into which the inlet discharges. The bulk goods container has a closure with a connection flange and a closure member. The connection flange is provided with an outlet for bulk goods received in the bulk goods container, and through which the bulk goods may flow when the outlet is open. The closure member is configured and arranged for closing and selectively opening the outlet. The emptying device comprises a closure actuating device mounted on the base structure or on the connection part which is configured for actuation of the closure (and/or the closure member) of the bulk goods container. The connection flange of the bulk goods container may be tightly joined to the connection part of the emptying device, such that—when the bulk goods container and/or its connection flange is connected to the emptying device—when the closure is opened, bulk goods may flow through the outlet out of the bulk goods container, through the inlet into the through-flow channel and subsequently through the through-flow channel.

The closure actuating device is provided with a closure actuating element and an adjustment device. The adjustment device is configured and arranged such that the closure actuating element may be selectively displaced relative to the connection part by means of the adjustment device between a closed position and at least one open position. When the closure is connected to the connection part, the closure actuating element in turn is coupled to the closure member such that the closure member may be actuated via the closure actuating element by means of the closure actuating device.

The closure actuating element is further provided with a drive unit of which the outer periphery may be selectively altered and/or adjusted and the closure member is provided with a driving stop which is configured and arranged on the closure member such that when the bulk goods container is connected to the connection part of the emptying device, the driving unit, depending on its periphery, either drives, or does not drive, the driving stop together with the closure member when the closure actuating element is displaced by means of the adjustment device. As a whole, by means of the driving unit on the closure actuating element and the driving stop on the closure member, the possibility arises for the selectively repeatedly releasable coupling of the closure actuating element to the closure member.

It is clear that this aspect of the invention does not necessarily have to be used in connection with the provision of a pneumatic gas supply for fluidising the bulk goods in the bulk goods container or with a piston-cylinder arrangement for the drive of a closure actuating element or with a blade unit for cutting off a cover configured as an integral component of a flexible container wall.

Preferably the driving unit is configured and arranged on the connection part such that its outer periphery may be automatically altered and/or adjusted. As a result, the possibility is provided for automatic coupling of the closure actuating element to the closure member and an automatic connection of the bulk goods container to the emptying device which, in particular, is advantageous in the case of toxic bulk goods.

The driving unit may, for example, be configured as a ring or as a circular disc, of which the circumference may selectively be altered. The driving unit may, in particular, be made as a three-dimensional structure from a flexible material of which the outer periphery may be altered, by the structure being compressed or expanded transversely to the plane of the periphery, as required. The structure may additionally be filled and sealed in an airtight manner. As a result, when the structure is compressed in a direction transverse to the peripheral plane, the outer circumference of the structure increases as, on the one hand the air pressure increases in the structure and on the other hand the cylindrical surface of the structure bulges outwards transversely to the direction of compression. Preferably, the alteration of the periphery is produced by compression and/or expansion of the driving unit by a pneumatic actuation of at least one press, which presses onto the driving unit, the press being able to be provided with a pressing plate.

The driving stop may be configured as a groove in an inner wall of a hollow closure member. The driving unit of the closure actuating element may therefore be arranged in this inner space such that it engages in this groove when the outer periphery is enlarged, whilst when the outer periphery is reduced, it does not engage in this groove. In the case of a groove-shaped driving stop completely enclosing the driving unit along the peripheral line, the driving unit may simultaneously serve as a selectively repeatedly releasable clamping seal which seals the intermediate space between the closure member and closure actuating element and/or the driving unit.

According to a further advantageous aspect of the invention, an emptying device for emptying bulk goods from a bulk goods container has a base structure, a connection part provided with an inlet and a through-flow channel, into which the inlet discharges. The bulk goods container has a closure with a connection flange and a closure member. The connection flange is provided with an outlet for bulk goods received in the bulk goods container, through which the bulk goods may flow when the outlet is open. The closure member is configured and arranged for closing and selectively opening the outlet. The emptying device comprises a closure actuating device mounted on the base structure or on the connection part, which is configured for the actuation of the closure (and/or the closure member) of the bulk goods container. The connection flange of the bulk goods container may be tightly joined to the connection part of the emptying device such that—when the bulk goods container and/or its connection flange is/are connected to the emptying device—when the closure is opened, bulk goods are able to flow through the outlet from the bulk goods container, through the inlet into the through-flow channel and subsequently through the through-flow channel.

The connection part is further provided with at least one locking element which is connected in a tension-proof manner to the connection part. Furthermore, the connection flange is provided with at least one locking receiver which is connected in a tension-proof manner to the connection flange. The locking element and the locking receiver are configured and arranged on the connection part and/or on the connection flange such that when the bulk goods container is arranged relative to the emptying device such that the connection flange impacts in one direction (hereinafter denoted as the impact direction) against the connection part—the locking element may be received in the locking receiver such that a positive connection acting in a tension-proof manner counter to the impact direction is created between the connection part and the connection flange. As a whole, by means of the locking element on the connection part and the locking receiver on the connection flange, the possibility arises for the selectively repeatedly releasable positive connection, which acts counter to the impact direction, between the connection part and the connection flange arranged to impact therewith.

It is clear that this aspect of the invention does not necessarily have to be used in connection with the provision of a pneumatic gas supply for the fluidising of the bulk goods in the bulk goods container or with a piston-cylinder arrangement for the drive of a closure actuating element or with a blade unit for cutting off a cover configured as an integral component of a flexible container wall or a driving unit with a selectively adjustable periphery for the selectively repeatedly releasable coupling of the closure actuating element to the closure member.

The locking element may be configured as a T-shaped or L-shaped bolt which projects outwardly from an outer side of the connection part and may engage into a correspondingly configured recess or groove in the connection flange. In this connection, the bolt may be selectively rotated about a bolt axis in order to be able to engage, or to be able to release, selectively by means of the bolt head, a retaining edge or a retaining projection of the locking receiver, in order to create, thus, a selectively repeatedly releasable positive connection between the connection part and the connection flange. The locking device formed from the locking element and locking receiver is preferably automatically actuatable. It may, in particular, also be configured according to a type of bayonet closure.

According to a further advantageous aspect of the invention, an emptying device for emptying bulk goods from a bulk goods container has a base structure, a connection part provided with an inlet and a through-flow channel, into which the inlet discharges. The bulk goods container has a closure with a connection flange and a closure body which is made from a rigid material (for example metal or plastics). The connection flange is provided with an outlet for bulk goods received in the bulk goods container, through which the bulk goods may flow when the outlet is open. The closure body is configured and arranged for closing and selectively opening the outlet. It is substantially arranged in an interior of the bulk goods container provided for receiving bulk goods, in particular it being able to form in its closed position a part of the container wall of the bulk goods container. The connection flange of the bulk goods container may be tightly joined to the connection part of the emptying device such that—when the bulk goods container and/or its connection flange is/are connected to the emptying device—when the closure is opened, bulk goods are able to flow through the outlet out of the bulk goods container through the inlet into the through-flow channel and subsequently through the through-flow channel. The emptying device further comprises a closure actuating device mounted on the base structure or on the connection part which is configured for an actuation of the closure of the bulk goods container.

The closure actuating device is additionally provided with a rotary drive which may be coupled to the closure body such that the closure body may be rotated by means of the rotary drive about a rotational axis (hereinafter denoted as the first rotational axis) which is stationary relative to the connection part of the emptying device. The closure body is configured and arranged such that it may be coupled to the rotary drive. Additionally, the closure body may be rotated relative to the connection flange about a rotational axis which is stationary relative to the connection flange (hereinafter denoted as the second rotational axis). In a coupled state (i.e. when the rotary drive is coupled to the closure body) the first rotational axis and the second rotational axis coincide so that then the closure body may be rotated relative to the connection part of the emptying device and relative to the connection flange of the closure of the bulk goods container about a single common rotational axis.

As the closure body is rotated relative to the connection flange (and thus relative to the bulk goods container), the bulk goods may be further loosened up. Due to this additional loosening up of the bulk goods, the reliability of the emptying process may be further improved.

It is clear that this aspect of the invention does not necessarily have to be used in connection with the provision of a pneumatic gas supply for fluidising the bulk goods in the bulk goods container or with a piston-cylinder arrangement for the drive of a closure actuating element or with a blade unit for cutting off a cover configured as an integral component of a flexible container wall or a driving unit with a selectively adjustable periphery for the selective releasable coupling of the closure actuating element to the closure member or a positive locking between the connection part and the connection flange.

For coupling the closure body to the rotary drive, separate coupling means may be provided, said coupling means being able to be actuated mechanically and/or pneumatically and/or hydraulically. The closure body and the rotary drive themselves may, however, also be configured such that they may be coupled to one another such that the rotary drive drives the closure body in rotation about the first and/or the second rotational axis.

During the emptying process, the bulk goods container is connected to the connection flange of its closure on the connection part of the emptying device. The bulk goods container is then substantially stationary relative to the emptying device. In the case of a closure actuating device which is further configured for displacing the closure body, the closure body may be rotated by means of the closure actuating device both relative to the container and, relative to the emptying device, may be displaced and may be rotated about a stationary rotational axis.

The rotary drive may be configured for a continuous, uniform rotation of the closure body about the first and/or the second rotational axis. As an alternative and/or complement the rotary drive may, however, also be configured such that it produces pulsating rotary movements or alternate rotary and/or oscillating movements in opposing rotational directions of the closure body.

The closure actuating device provided with the rotary drive may further comprise a closure actuating element which may be coupled to the closure body and an elongate drive shaft connected rigidly to the closure actuating element and which is arranged coaxially to the first rotational axis. In other words, the drive shaft has a longitudinal axis and is arranged such that its longitudinal axis coincides with the first rotational axis about which the closure body may be rotated relative to the connection part of the emptying device. The closure actuating device may further be provided with an adjustment device which is configured and arranged such that by means of the adjustment device the drive shaft together with the closure actuating element may be displaced selectively between a closed position and at least one open position substantially parallel (and thus in a straight line) to the first rotational axis. In this connection the rotary drive is coupled to the drive shaft such that the drive shaft may be rotated by means of the rotary drive relative to the connection part about the first rotational axis. The closure actuating element then may be displaced and rotated relative to the connection part. The closure actuating element may further be coupled to the closure body such that it produces the displacement and rotation of the closure body. In the case of an emptying device provided with a vibrator, additionally the vibrator is advantageously arranged and/or attached to this closure actuating element.

Preferably on the drive shaft one or more chopping elements (for example blades, vanes, prongs, spiral arms, plates etc.) are attached fixedly in terms of rotation and which project in the radial direction from the drive shaft. The chopping elements may be arranged in the through-flow channel and substantially include the entire cross-section of the through-flow channel. If the drive shaft is driven in rotation about the first rotational axis, these blades or plates ensure a mechanical chopping of possible clumps or bridges in the bulk goods. As a result, a further loosening up of the bulk goods is achieved which results in a further improvement of the emptying process.

As a complement and/or as an alternative to the one or the plurality of chopping elements, one or more bulk goods conveying elements may additionally be attached fixedly in terms of rotation to the drive shaft, such that during a rotation of the drive shaft about the first rotational axis, bulk goods are conveyed along the drive shaft in the manner of a conveyor worm or in the manner of a turbine, the conveyance of the bulk goods being carried out in the direction through the inlet and the through-flow channel. In the case of a drive shaft provided with chopping elements, these chopping elements may additionally be configured and arranged as conveying elements. A plurality of conveying elements may be provided which, similar to turbine blades or propeller blades, are configured and arranged in order to convey the bulk goods in the manner of a turbine. However, one or more thread configurations of a screw thread may be also provided in order to convey bulk goods in the manner of a conveyor worm.

Preferably one or more loosening element (for example vanes, blades, prongs, spiral arms, plates etc.) are further attached fixedly in terms of rotation to the closure body and which project at least partially into the interior of the bulk goods container provided to receive the bulk goods. When the closure body is driven in rotation about the rotational axis, these loosening elements ensure, in the vicinity of the closure body, mechanical chopping and loosening of possible clumps or bridges in the bulk goods which, in turn, leads to an improvement of the emptying process.

As a complement and/or as an alternative to the one or the plurality of loosening elements, additionally one or more bulk goods conveying elements are attached to the closure body, fixedly in terms of rotation, such that, when the closure body rotates about the second rotational axis, they convey bulk goods in the manner of a conveyor worm or in the manner of a turbine in the direction of the interior of the bulk goods container towards the outlet. In the case of a closure body provided with loosening elements, these loosening elements are additionally configured and arranged as conveying elements. A plurality of conveying elements may be provided which are configured and arranged in a similar manner to turbine blades or propeller blades in order to convey bulk goods in the manner of a turbine. However, one or more thread configurations of a screw thread may also be provided as conveying elements in order to convey bulk goods in the manner of a conveyor worm.

According to a further advantageous aspect of the invention an emptying device for emptying bulk goods out of a bulk goods container comprises a connection part provided with an inlet and a through-flow channel, into which the inlet discharges. The emptying device further comprises an emptying device-contact part which is at least partially made from and earthed by an electrically conductive material.

The bulk goods container has a closure with a connection flange and a closure member. The closure flange is provided with an outlet for bulk goods received in the bulk goods container, through which the bulk goods may flow when the outlet is open. The closure member is configured and arranged for closing and selectively opening the outlet. The bulk goods container further comprises a bulk goods container-contact part which is made at least partially from an electrically conductive material.

The connection flange of the bulk goods container may be tightly joined to the connection part of the emptying device such that—when the bulk goods container and/or its connection flange is/are connected to the emptying device—when the closure is open, bulk goods are able to flow through the outlet out of the bulk goods container, through the inlet into the through-flow channel and subsequently through the through-flow channel. When connected to the connection part, the bulk goods container-contact part is in contact with the emptying device-contact part and the bulk goods container-contact part is electrically conductively connected to the emptying device-contact part, by the electrically conductive material of the bulk goods container-contact part being in direct, electrically conductive contact with the electrically conductive material of the emptying device-contact part.

An electrically conductive material may, for example, be metallic material. It may, however, also be a material mix and or a composite material which is made up both from electrically conductive material and of electrically insulating material. In this sense, in the present connection an electrostatic discharge plastics material or a plastics material with an electrostatic discharge coating is understood by electrically conductive material. In the present connection, earthing is understood to be an electrically conductive connection with the ground and/or the earth, as is generally conventional.

The bulk goods container may, in particular, have flexible container walls and for example be configured as a bag or large container (also denoted as a “big bag” or “bulk bag”). As the bulk goods container-contact part during the emptying process is connected electrically conductively to the earthed emptying device, electrostatic loading of the bulk goods container-contact part and the bulk goods container connected thereto is prevented during emptying of the bulk goods, without, to this end, the bulk goods container having to be earthed during the emptying process, by means of additional electrical cables. With previously known emptying devices and bulk goods containers with flexible container walls, the bulk goods containers always had to be earthed during the emptying process, by means of additional electrical cables, in order to prevent electrostatic loading of the container.

It is understood that this aspect of the invention does not necessarily have to be used in connection with the provision of a pneumatic gas supply for fluidising the bulk goods in the bulk goods container or with a piston-cylinder arrangement for the drive of a closure actuating element or with a blade unit for cutting off a cover configured as an integral component of a flexible container wall or a driving unit with a selectively adjustable periphery for the selectively releasable coupling of the closure actuating element to the closure member or a positive locking between the connection part and the connection flange or the loosening up of the bulk goods by rotation of the closure member.

Preferably the connection part of the emptying device is simultaneously configured as an emptying device-contact part and the connection flange of the bulk goods container simultaneously configured as a bulk goods container-contact part. In this case, the connection part is at least partially made of and earthed by an electrically conductive material and the connection flange is also at least partially made from an electrically conductive material. The electrostatic unloading of the bulk goods container may thus take place via the connection flange of the bulk goods container and the connection part of the emptying device.

As a complement or as an alternative to a connection part configured as emptying device-contact part, the emptying device may further comprise a base structure and a closure actuating device mounted on the base structure or on the connection part and which is provided with a closure actuating element and with an adjustment device such that by means of the adjustment device the closure actuating element may be displaced selectively between a closed position and at least one open position, the closure actuating element being configured as an emptying device-contact part. In other words, the closure actuating element is at least partially made from and earthed by an electrically conductive material. Furthermore, according to this variant as a complement or as an alternative to a connection flange of the bulk goods container-closure configured as a bulk goods container-contact part, the closure body of this closure is configured as a bulk goods container-contact part, i.e. the closure body is made at least partially from an electrically conductive material. When the connection flange is connected to the connection part, the closure body is then in contact with the (electrically conductive and earthed) closure actuating element and the closure body is then electrically conductively connected to the closure actuating element. The electrostatic unloading of the bulk goods container may then be carried out via the closure body of the bulk goods container and the closure actuating element of the emptying device.

According to a further aspect of the invention a bulk goods container has a closure with a connection flange and a closure body which is made from a rigid material (for example metal or plastics). The connection flange is provided with an outlet for bulk goods received in the bulk goods container, through which the bulk goods may flow out when the outlet is open. The closure body is configured and arranged for closing and selectively opening the outlet. It is substantially arranged in an interior of the bulk goods container provided for receiving the bulk goods, in particular in its closed position being able to form a part of the container wall of the bulk goods container. Additionally, the closure body comprises a hollow space open towards the outlet. The connection flange of the bulk goods container is tightly joined to a connection part of an emptying device provided with an inlet, such that—when the bulk goods container and/or its connection flange is/are connected to the emptying device—when the closure is opened, bulk goods are able to flow through the outlet from the bulk goods container and through the inlet into the emptying device.

The closure further comprises a covering member. Said covering member may be connected to the connection flange, when the bulk goods container is connected to the emptying device, such that it covers and thereby protects the outlet on the outer side of the bulk goods container. If the connection flange has an outer side provided with a pneumatic gas inlet, the covering member may also cover and protect this outer side. The covering member is configured and arranged at least partially projecting through the outlet into the hollow space of the closure body, such that in turn it has a hollow space open outwardly which is substantially arranged within the hollow space of the closure body. The hollow space of the covering member is configured and dimensioned such that a further closure body may be partially received therein, which is part of a further closure of a further bulk goods container, the further bulk goods container, together with its closure and closure body, being configured identically to the first bulk goods container together with its closure and closure body.

As the hollow space of the covering member is substantially arranged in the hollow space of the closure body and a further identical closure body of a further identical closure may be partially received in the hollow space of the covering member, it is ensured that a plurality of closures configured identically to one another, may be stacked in a space-saving manner, together with their covering members.

It is clear, that this aspect of the invention does not necessarily have to be used in connection with the provision of a pneumatic gas supply for fluidising the bulk goods in the bulk goods container or with a piston-cylinder arrangement for the drive of a closure actuating element or with a blade unit for cutting off a cover configured as an integral component of a flexible container wall or a driving unit with a selectively adjustable periphery for the selectively releasable coupling of the closure actuating element to the closure member or with a positive locking between the connection part and the connection flange or with a closure body which is rotatable relative to the connection flange or with a bulk goods container-contact part made from an electrically conductive material.

Before the emptying of the bulk goods container by means of an emptying device to which the bulk goods container is connected, the covering member is either perforated or removed from the connection flange, in order to allow bulk goods to flow out through the outlet of the bulk goods container. The covering member may be a rigid body (i.e. a covering body) and be configured for selectively attaching to, and again removing from, the connection flange, in order to allow a multiple use of the covering member. The covering body made from a rigid material (for example metal or plastics) may in particular be configured as a conical shape corresponding to a conically configured closure body. The covering member may, however, also be a film which may be torn, torn off or perforated, etc. In this case, the covering member is simply provided for a disposable covering of the closure.

The covering member is preferably further configured such that, when connected to the connection flange, it mechanically secures the closure body and prevents the closure body from being inadvertently moved into the bulk goods container and thereby the closure being inadvertently opened. To this end, the covering member, for example, is provided with a screw thread and is connected by means of this screw thread and a corresponding screw thread which is configured on the closure body, to the closure body via a selectively releasable screw connection.

The bulk goods container with closures which are provided with a covering member, may comprise further flexible container walls (for example container walls which are made from paper, plastics film, textile fabric or similar foldable materials) and the hollow spaces of the covering member may be configured and dimensioned such that the closure body, together with the parts of the container walls covering said closure body, may be partially received in the hollow spaces of the covering members. As a result, it is ensured that a plurality of bulk goods containers configured to be identical to one another may be stacked, together with their closures, in a space-saving manner when the bulk goods container is empty and not connected to the emptying device.

According to a further advantageous aspect of the invention, a bulk goods container has a closure with a connection flange and a closure member. The connection flange is provided with an outlet for bulk goods received in the bulk goods container, through which the bulk goods are able to flow when the outlet is open. The closure member is configured and arranged for closing and selectively opening the outlet. The closure and/or its closure member may be actuated by means of a closure actuating device of an emptying device for emptying bulk goods from the bulk goods container. The emptying device further comprises a base structure, a connection part provided with an inlet and a through-flow channel into which the inlet discharges. The closure actuating device is mounted on the base structure. The connection flange of the bulk goods container may be tightly joined to the connection part of the emptying device such that—when the bulk goods container and/or its connection flange is/are connected to the emptying device—when the closure is open, bulk goods are able to flow through the outlet out of the bulk goods container, through the inlet into the through-flow channel and subsequently through the through-flow channel.

At least one surface part of the connection flange is configured and arranged such that, in the interior of the bulk goods container, it forms a part of the floor thereof and slopes in the direction towards the outlet in order to assist the outflow of the bulk goods. As a whole, the inclined surface of the connection flange forms a slideway on which the bulk goods may slide in the direction towards the outlet.

It is clear, that this aspect of the invention does not necessarily have to be used in connection with the provision of a pneumatic gas supply for fluidising the bulk goods in the bulk goods container or with a piston-cylinder arrangement for the drive of a closure actuating element or with a blade unit for cutting off a cover configured as an integral component of a flexible container wall or a driving unit with a selectively adjustable periphery for the selectively releasable coupling of the closure actuating element to the closure member or a positive locking between the connection part and the connection flange or with a closure body rotatable relative to the connection flange or with a bulk goods container-contact part made from an electrically conductive material or with a stackable closure.

The angle of inclination between the inclined surface part and a horizontal line, is located preferably in a range between approximately 15° and approximately 60°. For conventional bulk goods an angle of inclination of approximately 30° has proved to be suitable. In this connection, the inclined surface may as a whole be of funnel-shaped configuration in order to convey the bulk goods in the direction towards the outlet. It is clear that the closures of the bulk goods container according to different variants may be used not only for emptying the bulk goods container but also for filling the bulk goods container with bulk goods. To this end, a corresponding empty bulk goods container is firstly positioned such that the closure is arranged at the top of the bulk goods container, whereupon bulk goods are filled into the bulk goods container, through the bulk goods through-passage configured in the closure and/or in its connection flange.

Furthermore, the closures and emptying devices are also well suited for the use of so-called RFID (Radio Frequency Identification) components according to different variants, for the automatic identification both of the bulk goods container and also of its contents. To this end, a RFID reading and/or recording module may be built into a closure actuating element made of plastics, whilst so-called RFID tags (i.e. RFID identification elements) may be fitted on or in the closure bodies made of plastics. During or after connection of the bulk goods container, provided with corresponding closures, to the emptying devices provided with corresponding closure actuating elements, such a system thus offers the possibility of remotely reading data from the RFID tags and/or recording data thereon. In this manner the entire cycle of the bulk goods container and its contents may be continuously recorded. By means of the integration of the RFID components, which are no longer accessible from outside, into the closures and/or the emptying devices, a highly reliable and substantially fault-free identification may be achieved within the scope of the so-called supply chain management.

In the case of relatively large bulk goods containers, in order to be able to absorb the considerable forces which act on the closures, closures according to different variants may be further reinforced. Thus, for example a plastics flange part of such a closure (in the case of a two-part connection flange, in particular the outer flange part) may be provided with a reinforcing strip made from metal and/or fibre material (in particular glass or carbon fibres) and which is arranged along the outer periphery of the flange part.

Further advantageous embodiments and combinations of features of the invention are revealed from the subsequent detailed description and the entirety of the claims.

### BRIEF DESCRIPTION OF THE DRAWINGS

In the drawings used for explaining the embodiments:

FIG. 1 shows an emptying device and a bulk goods container according to a first preferred embodiment of the invention in a simplified, partially vertical, sectional partial view;

FIG. 2 shows an emptying device and a bulk goods container according to a second preferred embodiment of the invention in a simplified partially vertical, sectional partial view;

FIG. 3 shows an emptying device and a bulk goods container according to a third preferred embodiment of the invention in a simplified partially vertical, sectional partial view;

FIG. 4 shows the bulk goods container of FIG. 3 in a simplified vertical, sectional view;

FIG. 5 shows the bulk goods container of FIG. 3 and a further bulk goods container in a simplified vertical, sectional partial view;

FIG. 6 shows the bulk goods container of FIG. 1 and an emptying device according to a fourth preferred embodiment of the invention in a simplified vertical, sectional partial view;

FIG. 7 shows an emptying device and a bulk goods container according to a fifth preferred embodiment of the invention in a simplified vertical, sectional partial view;

FIG. 8 shows a bulk goods container according to a further preferred embodiment of the invention in a simplified vertical, sectional partial view with a covered outlet;

FIG. 9 shows the bulk goods container of FIG. 8 in a simplified, vertical sectional partial view with the cover removed from the outlet.

In principle, in the Figures the same parts are provided with the same reference numerals. Corresponding parts with the same function are provided in different embodiments of the invention, respectively with reference numerals which differ by a multiple of a hundred as a whole number.

### METHODS OF IMPLEMENTING THE INVENTION

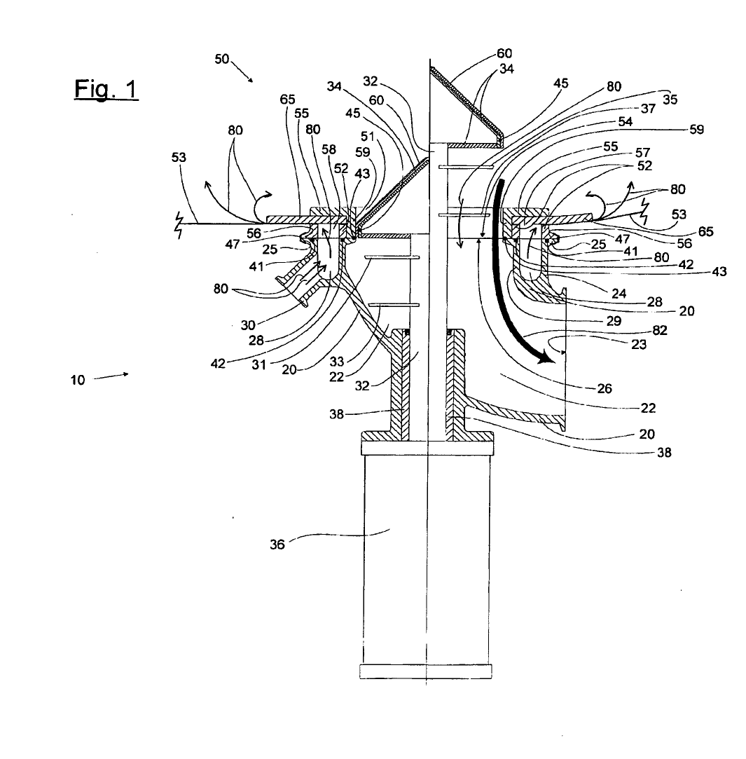

FIG. 1 shows an emptying device 10, to which a bulk goods container 50 is connected. The view in FIG. 1 is vertically split in the middle, on the left side the emptying device 10 and the bulk goods container 50 being shown in a closed position whilst on the right side the emptying device 10 and the bulk goods container 50 being shown in an open position.

The emptying device 10 comprises a housing 20 in which a through-flow channel 22 is configured with a circular cross-section. The housing 20 substantially has the shape of a right-angled curved tubular portion, the through-flow channel 22 being formed by the interior of this tubular portion. The housing 20 has a substantially planar, horizontally arranged circular upper face in which a circular opening 26 is configured which serves as an inlet 26 for bulk goods (not shown) flowing into the through-flow channel 22. The inlet 26 takes up the largest part of the surface of the housing upper face and discharges into a first (upper) end of the through-flow channel 22.

The uppermost part of the housing 20 which also comprises the housing upper face provided with the inlet 26, is configured as a connection part 24 of the emptying device 10. The connection part 24 is made from and earthed by an electrically conductive material. On the uppermost edge of the connection part 24 (which simultaneously also forms the uppermost outer edge of the housing 20) an annular collar 25 is formed which radially projects outwardly in a horizontal plane from the housing part connected inside and below, and serves for coupling the bulk goods container 50 to the emptying device 10.

In the uppermost part configured as a connection part 24, the through-flow channel 22 extends in the vertical direction. Subsequently, the through-flow channel 22 has a curved part thereunder which is formed by a right-angled curved lower part of the tubular housing 20. After the right-angled bending or curvature, the through-flow channel 22 discharges into an outlet 23 which is configured in a vertical outer side of the housing 20. As a whole, the through-flow channel 22 extends from the inlet 26, configured in the housing upper side, as far as the outlet 23, configured in a vertical outer side of the housing 20, firstly extending vertically downwards in the region of the inlet 26, bending at right angles in the lower region of the housing 20 and extending approximately horizontally in the region of the outlet 23.

A bulk goods suction line (not shown) may be attached to the outlet 23 and which is connected to an evacuation device (not shown) in order to assist the outflow of bulk goods from the bulk goods container 50 and through the through-flow channel 22, by producing a vacuum in the bulk goods suction line and in the through-flow channel 22.

In the upper face of the connection part 24, an upwardly open annular channel 28 (also denoted as a ring channel 28) is configured which serves as a compressed air outlet 28 of the emptying device 10. The annular channel 28 extends substantially in a horizontal plane (i.e. parallel to the upper face of the connection part 24) along the outer periphery of the inlet 26 and completely encloses said inlet. The annular channel 28 is defined below and on two sides by channel walls which are configured as parts of walls of the housing 20. In this connection, the side wall 29 of the annular channel 28 located inside in the radial direction is simultaneously configured as a channel wall 29 of the through-flow channel 22, which in its uppermost region defines said through-flow channel outwardly. In other words, the channel inner wall 29 of the annular channel 28 is simultaneously configured as an outer wall 29 of the through-flow channel 22. The side wall of the annular channel 28 located outside in the radial direction simultaneously forms an outer wall of the housing 20 and/or its connection part 24.

The annular channel 28 is further provided with a compressed air connection 30 which comprises a through-passage discharging obliquely from below into the annular channel 28 through which compressed air may be supplied into the annular channel 28. To the compressed air connection 30 a compressed air supply line (not shown) may be attached, which is connected to a compressed air source (not shown) in order to supply the annular channel 28 with compressed air. The thin arrows 80 in FIG. 1 show the compressed air flow 80 and/or its flow direction.

The emptying device 10 is further provided with a closure actuating device for selectively opening and closing a closure of the bulk goods container 50. The closure actuating device comprises an elongate drive shaft 32, a closure actuating element 34 and an adjustment device 36.

The drive shaft 32 has a circular cylindrical shape and a shaft axis defined by the axis of the circular cylinder. The drive shaft 32 is received in a through-passage of a guide bush 38 and may be displaced through the guide bush 38 in the direction of the shaft axis and rotatably guided about the shaft axis. The through-passage of the guide bush 38 leads from below, through a wall of the housing 20 into the through-flow channel 22, this wall forming a part of the defining wall of the through-flow channel 22 in its lower arcuate part. The guide bush 38 is fixedly attached to this wall. The drive shaft 32 is arranged in the arrangement which guides through the through-passage of the guide bush 38, such that the shaft axis or its extension extends in the vertical direction through the centre of the inlet 26, an upper part of the drive shaft 32 being arranged in the through-flow channel 22, whilst a lower part of the drive shaft 32 being arranged below and outside the through-flow channel 22.

The closure actuating element 34 is connected at the uppermost part to the drive shaft 32. Said closure actuating element is a substantially conical body made from a rigid material which is connected with its bottom face to the uppermost end of the drive shaft 32 such that the axis of the conical closure actuating element 34 is arranged coaxially to the axis of the drive shaft 32, the tip of the cone forming the uppermost part and the circular bottom face of the cone forming the lowest part of the closure actuating element 34. The closure actuating element 34 is made from and earthed by an electrically conductive material.

In the region of the bottom face, a driving ring 45 is connected to the outer peripheral surface of the closure actuating element 34. The driving ring 45 is made from a resilient material with a comparatively high coefficient of adhesion. It serves to create a non-positive connection between the closure actuating element 34 and a closure body 60 resting on the closure actuating element 34 and to drive the latter by means of frictional force, when the closure actuating element 34 rotates about its axis (i.e. the axis of its cone) or is displaced longitudinally to this axis.

At the lowest point, the drive shaft 32 is coupled to the adjustment device 36 such that it may be displaced and/or adjusted vertically upwards and downwards by means of the adjustment device 36, selectively in the direction of the shaft axis relative to the housing 20. The position where the drive shaft 32 is displaced maximally downwards is denoted as the closed position (shown in FIG. 1 on the left side) and the position where the drive shaft 32 is displaced maximally upwards is denoted as the fully open position (shown in FIG. 1 on the right side) of the emptying device 10 and/or its drive shaft 32. If the drive shaft 32 is arranged between its closed position and its fully open position, this is denoted as the partially open position of the emptying device 10 and/or its drive shaft 32.

The adjustment device 36 is further configured simultaneously as a rotary drive 36 by means of which the drive shaft 32 may be pivoted and/or rotated to and fro relative to the housing 20, selectively about the shaft axis by 360 degrees. The adjustment device 36 is mounted on the housing 20 and arranged completely outside the through-flow channel 22 and therebelow.

A plurality of blades 31, 33, 35, 37 are connected fixedly in terms of rotation to the drive shaft 32 below the closure actuating element, and which project in the radial direction away from the drive shaft 32. In the closed position of the emptying device 10 the blades 31, 33, 35, 37 are completed arranged within the through-flow channel 22. In the partially or fully open positions of the emptying device 10, the blades are arranged in the through-flow channel 22 or immediately above the inlet 26 over the through-flow channel 22. If, during the emptying process, the drive shaft 32 is pivoted to and fro about the shaft axis, the blades 31, 33, 35, 37 serve as chopping elements 31, 33, 35, 37 for cutting possible clumps present in the bulk goods flowing out.

The bulk goods container 50 shown in FIG. 1 is a bag 50 with a flexible container wall 53 and/or bag wall 53 which is made from paper and has the shape of a case which is closed on all sides as far as the closure described below. In the lowest region of the bag wall 53 forming the base of the bag 50, a closure is inserted. The closure has a connection flange 51, 52, a closure body 60 and a shut-off body 65 configured as a non-return sealing lip.

The connection flange is made up of an inner flange part 51 and an outer flange part 52 which are both of annular configuration and arranged in the view of FIG. 1 such that their annular axes coincide and extend substantially vertically. The two flange parts 51, 52 are made from an electrically conductive material. The inner flange part 51 has a circular cylindrical shell-shaped part 59 which has the shape of a tubular portion and laterally defines a substantially vertically extending circular cylindrical through-passage 54 which serves as an outlet 54 for bulk goods (not shown) received in the bag 50. At the upper end of the inner flange part 51 a radially outwardly projecting part 55 is formed (i.e. horizontally) which has the shape of a planar annular disc and is arranged at right angles to the cylindrical shell-shaped part 59 of the inner flange part 51. The outer flange part 52 has the shape of a thick annular disc with a central through-passage of which the diameter is slightly smaller than the external diameter of the cylindrical shell-shaped part 59 of the inner flange part 51 so that this cylindrical shell-shaped part 59 may be inserted by an interference fit into the central through-passage in the annular external flange part 52. In the view of FIG. 1 the cylindrical shell-shaped part 59 of the inner flange part 51 is inserted from above into the central through-passage in the outer flange part 52 so that the two flange parts 51, 52 are fixedly connected to one another by means of an interference fit. The external diameter of the outer flange part 52 substantially corresponds to the external diameter of the annular disc-shaped upper part 55 of the inner flange part 51.

An annular collar 56 is formed on the lowest outer edge of the outer flange part 52 (which simultaneously also forms the lowest outer edge of the entire connection flange) which in a horizontal plane projects radially outwardly from the part of the outer flange part 52 connected inside and outside and which serves for coupling the flange part 52 and/or the bag 50 to the connection part 24 of the emptying device 10. The collar 56 formed at the lowest point on the connection flange 51, 52 has the same outer periphery as the collar 25 formed uppermost on the connection part 24 of the emptying device 10.

In the outer flange part 52 a plurality of circular compressed air through-passages 57, 58 are configured which each have a diameter which corresponds to the maximum channel width of the annular channel 28 configured in the upper face of the connection part 24. The compressed air through-passages 57, 58 lead through the outer flange part 52 in the vertical direction. They are arranged along the entire periphery of the annular outer flange part 52 on a circle with a diameter corresponding to the diameter of the annular channel 28 (i.e. eccentrically relative to the annular outer flange part 52) and serve as compressed air inlets 57, 58 through which compressed air is able to flow into the bag 50.

The shut-off body 65 is made from a flexible, resilient plastics material and has the shape of a planar, circular disc with a central through-passage of which the diameter corresponds to the external diameter of the cylindrical shell-shaped part 59 of the inner flange part 51. The external diameter of the shut-off body 65 is substantially larger than the external diameter of the annular disc-shaped part 55 of the inner flange part 51 and/or the external diameter of the outer flange part 52.

The case-like bag wall 53 has a circular opening in its lowest region (also denoted as the base of the bag 50) of which the diameter also corresponds to the external diameter of the cylindrical shell-shaped part 59 of the inner flange part 51. The shut-off body 65 and the base of the bag 50 are arranged with superimposed through-passages and/or openings such that the cylindrical shell-shaped part 59 of the inner flange part 51 is inserted from above downwards, consecutively through the through-passage in the shut-off body 65, through the opening in the base of the bag and into the central through-passage in the outer flange part 52. The bag wall 53 is bonded to the upper face of the outer flange part 52 in the region of the bag opening. Furthermore, the bag wall 53, in the region of the bag opening, and the shut-off body 65, in the region of its central through-passage, are clamped between the lower face of the annular disc shaped part 55 of the inner flange part 51 and the upper face of the outer flange part 52 and held thereby and/or connected thereto on the connection flange, in the vicinity of the outlet 54 the bag wall 53 being arranged between the outer flange part 52 and the shut-off body 65 and the latter being arranged between the bag wall 53 and the annular disc-shaped part 55 of the inner flange part 51. In other words, this means that the connection flange and the shut-off body 65 made up of the inner flange part 51 and the outer flange part 52 are clamped in the vicinity of the outlet 54 (i.e. in the vicinity of the bag opening) to the bag wall 53 and partially bonded thereto.

In those parts of the bag wall 53 which are arranged directly over the compressed air through-passages 57, 58 configured in the outer flange part 52, compressed air through-passages are also configured in the bag wall. These compressed air through-passages are namely covered by the shut-off body 65 located immediately above and—when no overpressure prevails or simply a lower overpressure prevails in the compressed air through-passages 57, 58—tightly sealed. When in the compressed air through-passages 57, 58, however, a greater overpressure prevails, the shut-off body 65 made from a flexible material is slightly deformed by the compressed air, so that compressed air from the upper end of the compressed air through-passages 57, 58 may flow laterally outwards between the shut-off body 65 and the bag wall 53 into the interior of the bag 50. The compressed air flow 80 and/or its flow direction is shown in FIG. 1 by the thin arrows 80.

As a whole, the shut-off body 65 serves simultaneously as a shut-off body and a return spring of non-return valves which seal the compressed air through-passages 57, 58 towards the interior of the bag 50 and allow a compressed air flow 80 into the bag 50 but prevent a compressed air and/or bulk goods flow in the opposite direction out of the bag.

The radial outer region of the circular disc-shaped shut-off body 65 projects over the outer edge of the inner flange part 51 and the outer flange part 52 and projects into the interior of the bag 50. If compressed air between the bag wall 53 and the shut-off body 65 flows through into the bag 50, this projecting region of the shut-off body 65 is made to oscillate (also denoted as fluttering). The oscillations are thus transmitted to the bulk goods received in the interior of the bag 50 and loosen up the bulk goods.

The closure body 60 is configured and arranged for selectively closing and opening the outlet 54. It is made from a rigid electrostatic discharge plastics material and configured as a hollow, thin walled cone, the cone shape of the similarly conical interior of the closure body 60 substantially corresponding to the outer shape of the conical closure actuating element of the emptying device 10. In the view shown in FIG. 1, the closure body 60 is arranged such that the axis of symmetry of the conical closure body is vertical and is arranged coaxially to the axis of the drive shaft, the tip of the cone forming the uppermost part and the circular, downwardly open base surface of the cone forming the lowest part of the closure body 60. The maximum diameter of the cone 60 in the region of its base surface is slightly smaller than the internal diameter of the outlet 54 configured in the inner flange part 51 so that the lowest region of the closure body 60 may be arranged with a clearance fit in the outlet 54, in order to seal said outlet tightly, as is shown in FIG. 1 on the left side.

The closure body 60 may be displaced downwardly and upwardly relative to the connection flange 51, 52 in the vertical direction and may be lifted upwardly from the connection flange, in order to close or open up the outlet 54 and thereby to open the closure, as is shown in FIG. 1 on the right side. The position with the closure body 60 displaced maximally downwards is denoted as the closed position of the closure body 60 and the closure. In this position shown in FIG. 1 on the left side, the bottom face of the closure body 60 shown in FIG. 1 on the left side is arranged within the outlet 54 and tightly seals said outlet. The position where the closure body 60 is maximally displaced upwardly is denoted as a fully open position of the closure and/or the closure body 60. In this position shown in FIG. 1 on the right side, the entire closure body 60 is arranged above the outlet 54. Moreover, the closure body 60 is freely rotatable relative to the connection flange 51, 52 about the vertical axis of symmetry of the cone.

On the upper face of the connection part 24, three sealing rings 41, 42, 43 made from a resilient sealing material are further arranged such that in an unloaded state (i.e. when no bulk goods container is coupled to the emptying device 10) they at least partially project upwardly from the surface plane of the upper face. If—as shown in the view of FIG. 1—the connection flange 51, 52 of the bulk goods container 50 is coupled to the connection part 24 of the emptying device 10, the sealing rings 41, 42, 43 between the adjoining surfaces of the connection flange 51, 52 and the connection part 24 are pressed together and thus seal the through-passages which lead through these surfaces and through which bulk goods and/or air may flow out of the bulk goods container 50 into the emptying device 10 and compressed air from the emptying device 10 into the bulk goods container 50. A first sealing ring 41 is arranged along the outer periphery of the annular channel 28 and seals the annular channel 28 outwardly. A second sealing ring 42 is arranged along the inner periphery of the annular channel 28 and seals the annular channel 28 inwardly. A third sealing ring 43 is arranged along the outer periphery of the inlet 26 and seals the inlet and/or the through-flow channel 22 in the upper face of the connection part 24.

In order to empty bulk goods from the bag 50 shown in FIG. 1 by means of the emptying device 10 shown in FIG. 1, firstly a covering member possibly arranged on the connection flange 51, 52 of the bag 50 is removed from the connection flange 51, 52. The closure of the bag 50 and the closure actuating device of the emptying device 10 are located in their closed positions. Then the bag 50, together with the connection flange 51, 52, is transported over the housing 20 of the emptying device 10. Subsequently, the coupling process is initiated for coupling the bag 50 to the emptying device 10, by the bag 50 being lowered towards the housing 20. During the lowering of the bag 50 the closure body 60 which is open downwards is positioned over the closure actuating element 34 projecting upwardly over the upper face of the connection part 24 of the housing 20, whereby the connection flange 51, 52 together with the bag 50, is centred relative to the connection part 24 and/or the housing 20 and precisely aligned thereto. The bag 50 is lowered until the connection flange 51, 52 rests with its lower face on the upper face of the housing 20 and/or its connection part 24. The collar 56 formed at the lowest point on the connection flange 51, 52 now rests directly on the collar 25 formed uppermost on the connection part 24. Subsequently, the connection flange 51, 52 is clamped, by means of annular retaining clips 47, to the connection part 24 of the emptying device 10. Thus the coupling process is completed and the bag 50 is now coupled to the emptying device 10 shown in FIG. 1.

As a whole, the connection part 24 provided with the collar 25 forms a first structural unit on the emptying device side and the connection flange 51, 52 provided with the collar 56 forms a structural unit of a coupling device on the second bag side which is configured for the selectively repeatedly releasable connection of the connection flange 51, 52 to the connection part 24. The first and second structural unit may be coupled and/or may be connected to one another in a single coupling process, in order to connect and/or couple the connection flange 51, 52 of the bag 50 provided with the outlet 54 and the compressed air inlet 57, 58 to the connection part 24 of the emptying device 10 provided with the inlet 26 and the compressed air outlet 28.

In the coupled state shown in FIG. 1, the connection flange 51, 52 and the connection part 24 are held together by means of the annular retaining clips 47 which, along the entire outer periphery of the connection flange 51, 52 and/or the connection part 24, engage the collar 56 formed on the connection flange 51, 52, outside and above, and the collar 25 formed on the connection part 24, outside and below. In the coupled state shown in FIG. 1, the through-passages 57, 58 configured in the outer flange part 52, are arranged directly over the upwardly open annular channel 28, so that compressed air is able to flow from the annular channel 28 through the through-passages 57, 58 into the bag 50. Additionally, in the coupled state shown in FIG. 1 the outlet 54 of the bag is arranged directly over the inlet 26 of the emptying device 10, so that bulk goods and air are able to flow through the outlet 54 out of the bag 50 and through the inlet 26 into the through-flow channel 22.

In order to initiate the emptying process, firstly the drive shaft 32 is displaced upwardly by means of the adjustment device 36. As a result, the closure actuating element 34 connected at the uppermost point to the drive shaft 32, which is already arranged in the interior of the closure body 60, is pressed from below against the closure body 60 and lifts said closure body up in order to lift the closure body 60 from the outlet 54 and, as a result, to open the closure of the bag 50 formed by the connection flange 51, 52 and the closure body 60. In this connection, the driving ring 45 is pressed between the closure actuating element 34 and the closure body 60 and thereby ensures a frictional connection, fixed in rotation, between the closure actuating element 34 and the closure body 60. The closure body 60 is lifted by means of the closure actuating device 32, 34, 36 to a height corresponding to the desired metering of the bulk goods flow. On the right side of FIG. 1 the closure body 60 is shown at its maximum height over the outlet. This open position of the closure results in a maximum flow of bulk goods from the bag 50.

As soon as the closure body 60 is lifted from the outlet 54, bulk goods begin to flow out substantially vertically downwards through the outlet out of the bag 50. The thick arrow 82 in FIG. 1 shows the flow of the bulk goods 82 and/or its flow direction when the closure is open.

In order to assist the outflow of bulk goods from the bag 50, by means of the rotary drive of the adjustment drive 36 the drive shaft is pivoted to and fro about the shaft axis. As a result, the closure actuating element 34 and the closure body 60 driven thereby by the driving ring 45 is also pivoted to and fro, which leads to a loosening up of the bulk goods resting on the closure body 60. Additionally, the blades 31, 33, 35, 37, also connected to the drive shaft 32, are also pivoted to and fro, whereby possible clumps of bulk goods are reduced in size in the pivoting region of the blade.

Furthermore, compressed air is blown through the compressed air connection 30, the compressed air outlet 28, the compressed air inlet 57, 58 and between the bag wall 53 and the shut-off body 65 into the bag 50 and, by means of the evacuation device connected via the bulk goods suction line to the outlet 23, simultaneously produces a vacuum in the through-flow channel 22. As a result, on the one hand the shut-off body 65 is stimulated to flutter which leads to a loosening of the bulk goods located on the shut-off body. On the other hand the air flow is produced in the bag 50 indicated by the arrow 80 which leads to a further loosening up of the bulk goods received in the bag 50 and additionally carries along the bulk goods through the outlet 54 out of the bag 50, through the inlet 26 into the through-flow channel 22 and through the through-flow channel 22.

In order to complete the emptying process, firstly the rotary drive of the adjustment device 36 is stopped and then the drive shaft 32 is lowered by means of the adjustment device 36, until the closed position shown in FIG. 1 on the left side is achieved again. Subsequently, the retaining clip 47 is removed from the collar 25, 56 and, as a result, the connection flange 51, 52 is decoupled from the connection part 24. Now the bag 50, together with the connection flange 51, 52, is lifted slightly from the connection part 24 and again produces a strong flow of compressed air from the compressed air connection. This compressed air flow blows away bulk goods possibly still present on the connection part 24 and/or on the connection flange 51, 52, whereupon the bulk goods blown away by means of the evacuation device are sucked up through the inlet and the through-flow channel. As a result, parts of the emptying device 10 and the bag 50 are cleaned. Subsequently, the compressed air flow is interrupted through the compressed air connection 30 and the compressed air outlet 28 and the suction flow is interrupted in the through-flow channel 22. It is desirable that the connection flange 51, 52 is able to be covered again with a covering member and subsequently the at least partially emptied bag 50 is transported away from the emptying device 10.

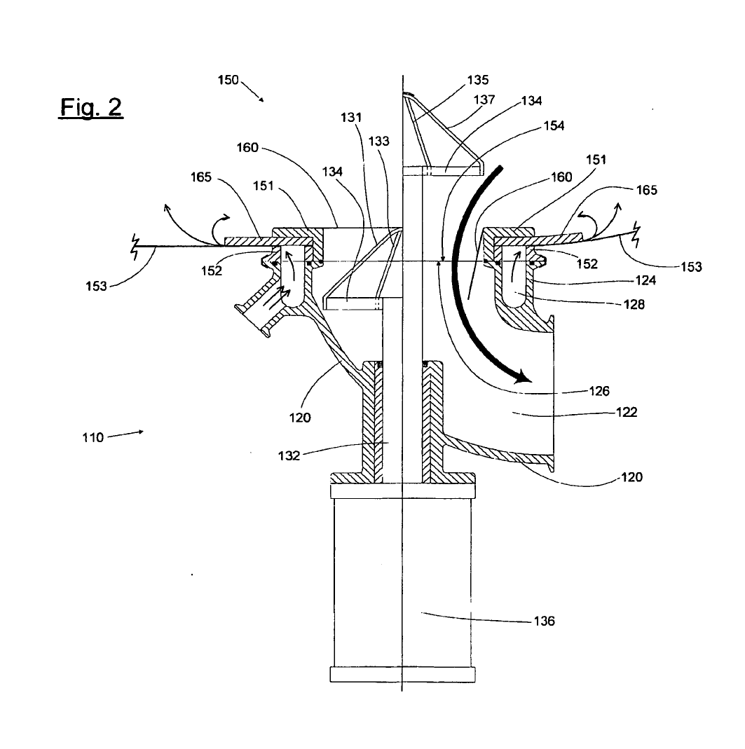

FIG. 2 shows an emptying device 110, to which a bulk goods container 150 is connected. The view in FIG. 2 is divided vertically in the middle, on the left side the emptying device 100 and the bulk goods container 150 being shown in the closed position, whilst on the right side the emptying device 110 and the bulk goods container 150 being shown in an open position.

The bulk goods container 150 and/or bag 150 differ from the bulk goods container 50 and/or bag 50 shown in FIG. 1, essentially merely relative to the configuration of the closure member 160 for closing the outlet 154. Otherwise, the bag 150 shown in FIG. 2 is substantially of the same configuration as the bag 50 shown in FIG. 1. The bag 150 shown in FIG. 2 has again a flexible bag wall 153 and a closure which is provided with a two-part connection flange 151, 152, a closure body 160 and a shut-off body 165. The two flange parts 151, 152 are made from an electrically conductive material.

The closure member 160 shown in FIG. 2 for closing the outlet 154 is a perforable film 160 made from a flexible film material which, in the closed state, is welded to the inner flange part 151 of the connection flange 151, 152 such that it completely closes the outlet 154 configured in the inner flange part 151. The closure formed by the film 160 and the connection flange 151, 152, is merely provided for opening the closure once, i.e. it is a disposable closure.

The emptying device 110 shown in FIG. 2 differs from the emptying device 10 shown in FIG. 1, essentially merely relative to the configuration of the closure actuating device 132, 134, 136 for closing and selectively opening the closure of the bag 150. Otherwise the emptying device 110 shown in FIG. 2 is substantially of the same configuration as the emptying device 10 shown in FIG. 1. The emptying device 110 shown in FIG. 2 has, in turn, a housing 120 provided with a through-flow channel 122 of which the upper part is configured as a connection part 124 and provided with an inlet 126 discharging into the through-flow channel 122 and a compressed air outlet 128. The connection part 124 is made from and earthed by an electrically conductive material.

The closure actuating device 132, 134, 136 shown in FIG. 2 comprises, in turn, an elongate drive shaft 132, a closure actuating element 134 and an adjustment device 136 for adjusting the drive shaft 132 in the direction of its longitudinal axis. The closure actuating element 134 is attached to the drive shaft 132 at the uppermost point, and is in turn configured as a conical body, the tip of the cone forming the uppermost part and the circular bottom surface of the cone, the lowermost part of the closure actuating element 134. In contrast to the closure actuating element 34 shown in FIG. 1, the conical shell-shaped outer side of the closure actuating element 134 shown in FIG. 2 is provided with a plurality of sharp cutting edges 131, 133, 135, 137, which serve to perforate and cut the film 160 of the closure of the bag 150.

In order to empty bulk goods from the bag 150 shown in FIG. 2 by means of the emptying device 110 shown in FIG. 2, firstly the bag 150 is coupled in a coupling process to the emptying device 110, this coupling process being the same, with the exception of the centering process, as the coupling process for coupling the bag 50 shown in FIG. 1 to the emptying device 10 shown in FIG. 1.

After coupling the bag 150 to the emptying device 110, by means of the adjustment device 136, the drive shaft 132 together with the closure actuating element 134 connected thereto is displaced upwardly. In this connection, the cutting edges 131, 133, 135, 137 are pressed against the outer side of the closure actuating element 134 from below against the film 160 such that they perforate and cut said film. As a result, the closure of the bag 150 formed by the connection flange 151, 152 and the film-shaped closure member 160 is opened.

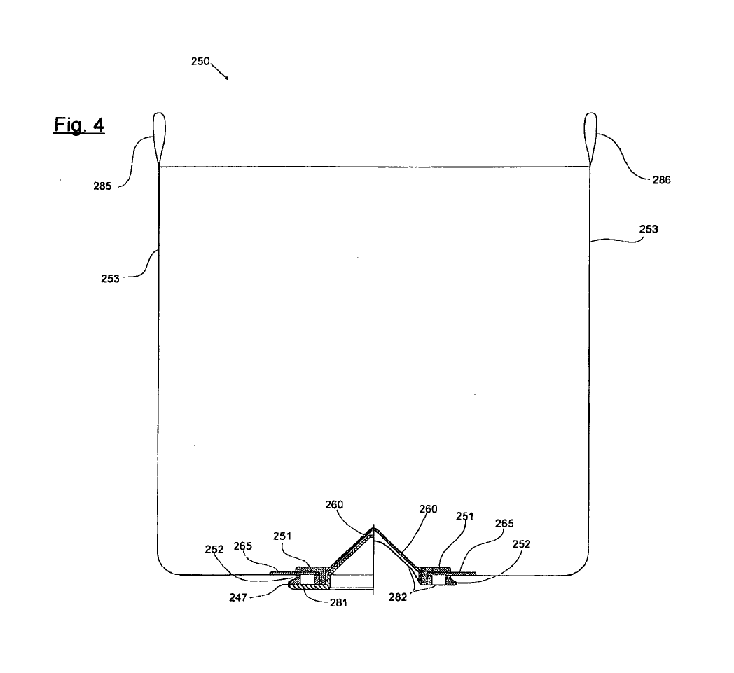

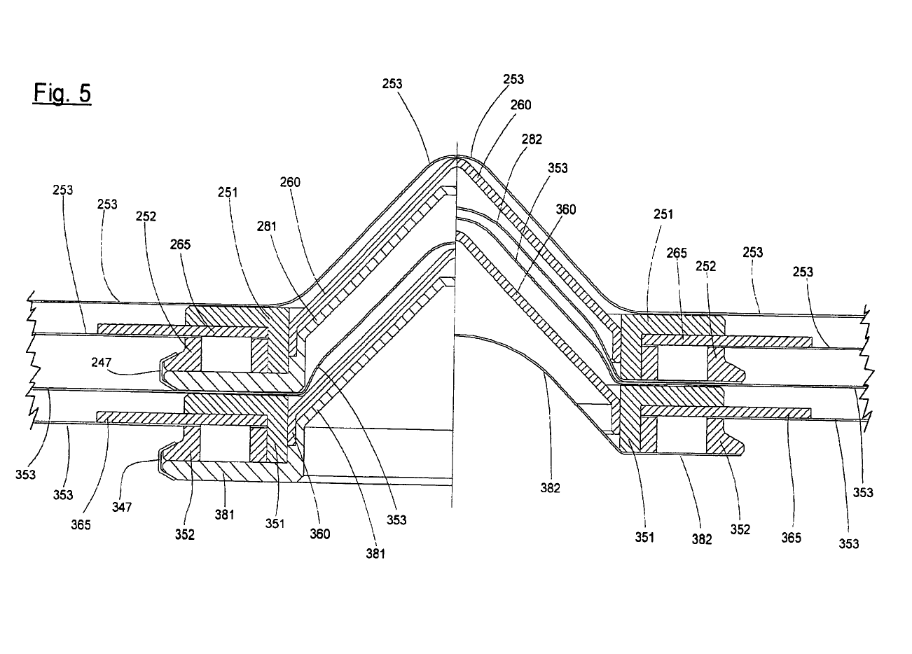

Subsequently, the bulk goods are completely emptied out of the bag 150 in an emptying process which is similar to the emptying process described above. A renewed closure of the bag 150 by means of the film 160 is no longer possible, but the bag 150 may, if required, by means of a covering body, as is described in more detail below in connection with FIGS. 4 and 5, be tightly sealed without contamination.

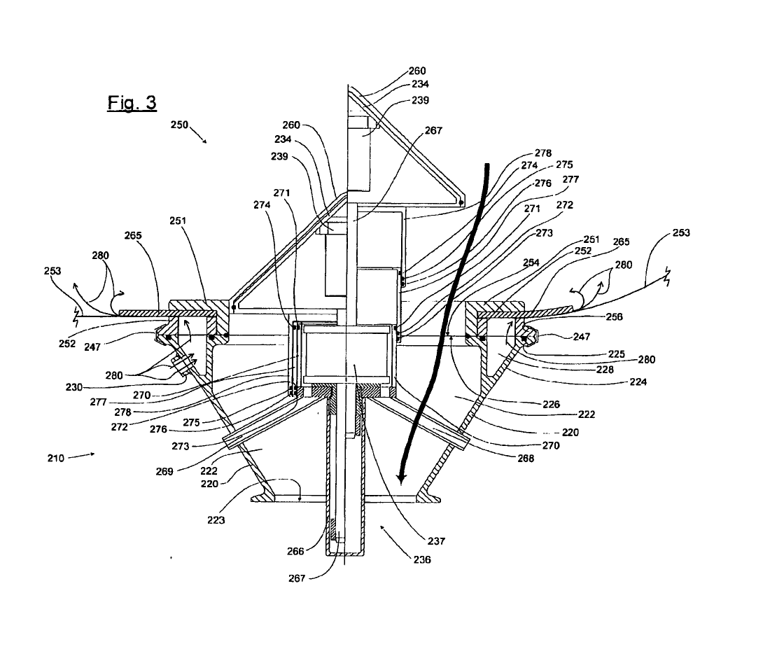

FIG. 3 shows an emptying device 210 to which a bulk goods container 250 is connected. The view in FIG. 3 is divided vertically in the middle, on the left side the emptying device 210 and the bulk goods container 250 being shown in a closed position, whilst on the right side the emptying device 210 and the bulk goods container 250 being shown in an open position.

The bulk goods container 250 shown in FIG. 3 is a bag-shaped large container 250 (also denoted as a “big bag” or “bulk bag”). In FIG. 4 this large container 250 is shown separately. FIG. 5 shows the large container 250 together with a further large container 350 identical thereto in an arrangement stacked on top of one another. The large container 250 shown in FIGS. 3-5, differs from the bag 50 shown in FIG. 1 relative to its dimensions and relative to a plurality of suspension tabs 285, 286 which are connected at the uppermost point to the flexible container wall 253 and allow it to suspend the large container 250 on a suspension device (for example a crane). Otherwise, the large container 250 shown in FIGS. 3-5 is of substantially the same configuration as the bag 50 shown in FIG. 1. The large container 250 has, in turn, a flexible container wall 253 and a closure which is of the same construction as the closure of the bag 50 shown in FIG. 1 and is provided with a two-part connection flange 251, 252, a conical closure body 260 and a shut-off body 265 made from a flexible material. The two flange parts 251, 252 are made from an electrically conductive material. The closure body 260 is made from a rigid electrostatic discharge plastics material.

The emptying device 210 shown in FIG. 3 comprises a funnel-shaped housing 220 in which a through-flow channel 222 is configured with a circular cross-section. The housing 220 has a substantially planar, horizontally arranged circular upper face in which a circular opening 226 is configured which serves as an inlet 226 for bulk goods (not shown) flowing into the through-flow channel 222. The inlet 226 takes up the largest part of the surface of the housing upper face and discharges into the upper end of the through-flow channel 222.

The through-flow channel 222 extends in a vertical direction from the inlet 226 downwards to an outlet 223, the diameter of the through-flow channel 222 reducing in size downwards due to the funnel shape of the housing 220.

The uppermost part of the housing 220 which also comprises the housing upper face which is also provided with the inlet 226, is configured as a connection part 224 of the emptying device 210. The connection part 224 is made from and earthed by an electrically conductive material. On the uppermost, outermost edge of the connection part 224 (which simultaneously also forms the uppermost, outer edge of the housing 220) an annular collar 225 is formed, which projects radially outwardly and serves to couple the bulk goods container 250 to the emptying device 210.

In the upper face of the connection part 224 an upwardly open annular channel 228 is configured which serves as a compressed air outlet 228 of the emptying device 210. The annular channel 228 is provided with a compressed air connection 230, to which a compressed air supply line (not shown) is connected which is connected to a compressed air source (not shown) in order to supply the annular channel 228 with compressed air. The thin arrows 280 in FIG. 3 show the compressed air flow 280 and/or its flow direction.

The emptying device 210 is further provided with a closure actuating device for selectively opening and closing a closure of the bulk goods container 250. The closure actuating device comprises a closure actuating element 234 and an adjustment device 236 which is provided with a piston-cylinder arrangement 270, 277, 278, a guide rod 267 and a rotary drive 237.

The piston-cylinder arrangement 270, 277, 278 comprises a piston 270 with a circular cylindrical outer shape which is fixedly connected to the housing 220 by means of connecting struts 268, 269 and is mounted in a stationary manner thereon. The piston 270 is received in a circular cylindrical hollow space of a first downwardly open hollow cylinder 277, such that the first hollow cylinder 277 may be displaced in a vertical direction relative to the piston 270. The outer shape of the piston 270 corresponds substantially to the shape of the hollow space of the first hollow cylinder 277. A first sealing ring 271 is arranged along the circular cylindrical shell-shaped outer side of the piston 270 from its upper edge and seals the intermediate space formed between the piston 270 and the first hollow cylinder 277 in an airtight manner against the exterior. A second sealing ring 272 and a first stripper ring 273 are arranged along the inner face of the first hollow cylinder 277 from its lower edge. They seal the intermediate space formed between the piston 270 and the first hollow cylinder 277 below the first sealing ring 271 additionally against the exterior and prevent the penetration of bulk goods or other contaminants into this intermediate space.

The first hollow cylinder 277 has, in turn, a circular cylindrical outer shape and is received in a circular cylindrical hollow space of a second downwardly open hollow cylinder 278, such that the second hollow cylinder 278 may be displaced in the vertical direction relative to the first hollow cylinder 277. A third sealing ring 274 is arranged along the circular cylindrical shell-shaped outer side of the first hollow cylinder 277 from its upper edge and seals the intermediate space formed between the first hollow cylinder 277 and the second hollow cylinder 278 in an airtight manner against the exterior. A fourth sealing ring 275 and a second stripper ring 276 are arranged on the inner face of the second hollow cylinder 278 along its lower edge. They seal the intermediate space formed between the first hollow cylinder 277 and the second hollow cylinder 278 below the third sealing ring 274 additionally against the exterior and prevent the penetration of bulk goods or other contaminants into this intermediate space.

To the uppermost point on the second hollow cylinder 278 is attached the closure actuating element 234 which is of similar configuration to the closure actuating element 34 shown in FIG. 1. The closure actuating element 234 is made from and earthed by an electrically conductive material.

A compressed air line (not shown) supplied with compressed air from an external compressed air source (not shown), leads through the piston 270 into the intermediate space between the piston 270 and the first hollow cylinder 277. A compressed air through-passage leads from this intermediate space to the intermediate space between the first hollow cylinder 277 and the second hollow cylinder 278. As a whole, a piston-cylinder arrangement is created by the piston 270, the first hollow cylinder 277 and the second hollow cylinder 278 with a piston 270 mounted on the housing 220 and two hollow cylinders 277, 278 which may be displaced in one another telescopically relative to the piston 270, the piston-cylinder arrangement 270, 277, 278 being actuatable pneumatically by means of the compressed air source in order to displace the second hollow cylinder 278 and the closure actuating element 234 attached thereto in the vertical direction relative to the housing 220 and/or the piston 270.

In order to guide the movement of the second hollow cylinder 278 accurately, a linear guide unit is provided with an elongate guide rod 267 which is rigidly attached to the second hollow cylinder 278. The guide rod 267 has a circular cylindrical shape and a rod axis defined by the axis of the circular cylinder which extends in the vertical direction. The guide rod 267 may be displaced in the vertical direction in a guide bush 266 attached rigidly to the housing 220 and rotatably guided around the rod axis, the guide rod 267 being further guided in the vertical direction through through-passages, which are configured in the piston 270 and in the first hollow cylinder 277. The linear guide unit 266, 267 ensures that the sealing and/or stripper rings 271-276 between the hollow cylinders 277, 278 and/or between the first hollow cylinder 277 and the piston 270 do not have to exert any guide forces and therefore are not excessively loaded.

In the piston 270, a rotary drive 237 is further mounted, by means of which the guide rod 267 and the second hollow cylinder 278 connected thereto may be pivoted and/or rotated to and fro relative to the piston 270 and/or the housing 220 selectively about the rod axis by 360 degrees. The guide rod 267 is thus simultaneously configured as a drive shaft 267, by means of which the closure actuating element 234 may be driven in rotation about the rod axis.

The entire adjustment device 236 formed from the piston-cylinder arrangement 270, 277, 278, the guide rod 267 and the rotary drive 237 is arranged within the through-flow channel 222. Due to the merely downwardly open hollow cylinder 277, 278, however, no additional screening means such as for example the roll membrane in the publication EP 0 915 032 are required, in order to protect the piston-cylinder arrangement from contamination by the bulk goods flowing through the through-flow channel 222.

The closure actuating element 234 shown in FIGS. 3-5 is a conical hollow body made from a rigid material which is attached with its bottom face to the uppermost point of the second hollow cylinder 278 of the adjustment device 236 and may be displaced in the vertical direction by means of the adjustment device 236 and may be pivoted to and fro about the axis of the guide rod 267.

In the hollow inner space of the closure actuating element 234 is additionally arranged a pneumatically actuatable vibrator 239 which may stimulate the closure actuating element 234 to oscillations or vibrating movements. In the open position of the emptying device 210 and the closure of the large container 250 (shown in FIG. 3 on the right side), the closure body 260 sits directly on the closure actuating element 234. The oscillations produced by the vibrator are then transmitted from the closure actuating element 234 to the closure body 260 and therefrom to the bulk goods surrounding said closure body, whereby an additional loosening up of the bulk goods is effected.

The entire emptying device 210 shown in FIG. 3, together with the connection flange 251, 252 of the large container 250 attached thereto may be moved in the vertical direction relative to a suspension device (not shown) on which the large container 250 is suspended. As a result, the possibility for continuous stretching of the large container 250 during the emptying process is created, in order to hold the entire flexible base of the large container 250 continually inclined in the direction of the outlet 254. As an alternative, for the same purpose, the suspension device may also be moved in the vertical direction relative to the emptying device 210.

FIG. 4 shows the large container 250 of FIG. 3 separately. The view in FIG. 4 is divided vertically in the middle. On the left side, the connection flange 251, 252 of the closure of the large container 250 is covered by a covering member 281 according to a first variant of the invention. On the right side, the connection flange 251, 252 of the closure of the large container 250 is covered by a covering member 282 according to a second variant of the invention.

The covering member 281 shown in FIG. 4 on the left side is a conical hollow body 281 made from a rigid material with a bottom face open downwards. The conical shape of the covering body 281 corresponds substantially to the conical shape of the closure body 260. An annular disc 263 projecting radially outwardly from the base surface of the conical shape is formed at the lowest point on the covering body 281, and of which the outer periphery substantially corresponds to the outer periphery of the outer flange part 252 of the connection flange 251, 252. The annular disc has, in the region of its outer periphery, an identical outer shape to the collar 225 of the connection part 224 of the emptying device 210 shown in FIG. 3. As a result, it is possible to clamp the covering body 281 by means of the same annular retaining clip 247 (or a retaining clip identical thereto) selectively repeatedly releasably to the connection flange 251, 252 which serves to clamp the connection flange 251, 252 to the connection part 224 of the emptying device 210 shown in FIG. 3, as is shown in FIGS. 4 and 5 respectively on the left side.

When clamped on the connection flange 251, 252, the covering body 281 is partially arranged projecting from below through the outlet 254 into the hollow space of the closure body 260, the hollow space of the covering body 281 open downwardly being arranged substantially within the hollow space of the closure body 260. In this state, the covering body 281 covers the entire connection flange 251, 252 on its lower face. Additionally, in this state the covering member 281 is selectively repeatedly releasably connected to the closure body 260, so that it mechanically secures the closure body 260 and prevents the closure body 260 from inadvertently being moved into the large container 250 and, as a result, the closure is inadvertently opened.

The covering member 281 shown in FIG. 4 on the right side is a covering film 282 made from a flexible film material. It is attached along the outer periphery of the connection flange on the lower face of the outer flange part 252 and covers the entire connection flange 251, 252 on its lower face. In the region within the inner flange part 251 the covering film projects from below through the outlet 254 into the hollow space of the closure body 260 upwards and forms, in turn, a downwardly open hollow space which is arranged substantially within the hollow space of the closure body 260.

FIG. 5 shows the large container 250 from FIGS. 3 and 4 together with a further identical large container 350 in an arrangement stacked on top of one another, the closures of the two large containers 250, 350 are each covered with identical covering members 281, 282; 381, 382. The view in FIG. 5 is divided vertically in the middle. On the left side the connection flanges 251, 252; 351, 352 of the closures of the large container 250; 350 are covered by covering bodies 281, 381 according to the views on the left side of FIG. 4. On the right side, the connection flanges 251, 252; 351, 352 of the closures of the large container 250, 350 are covered by covering films 282, 382 according to the views on the right side of FIG. 4.

According to the view on the left side of FIG. 5 the closure body 360 of the closure of the further large container 350 is partially received in the hollow space of the covering body 281, the covering part of the flexible container wall 353 of the further large containers 350 resting on its closure body 360 being arranged between this closure body 360 and the covering body 281 of the other large container 250.

In a similar manner according to the view on the right side of FIG. 5, the closure body 360 of the closure of the further large container 350 is partially received in the hollow space formed by the covering film 282 of the large container 250, the covering part of the flexible container wall of the further large container 350 resting on its closure body 360 being arranged between this closure body 360 and the covering film 282 of the other large container 250.

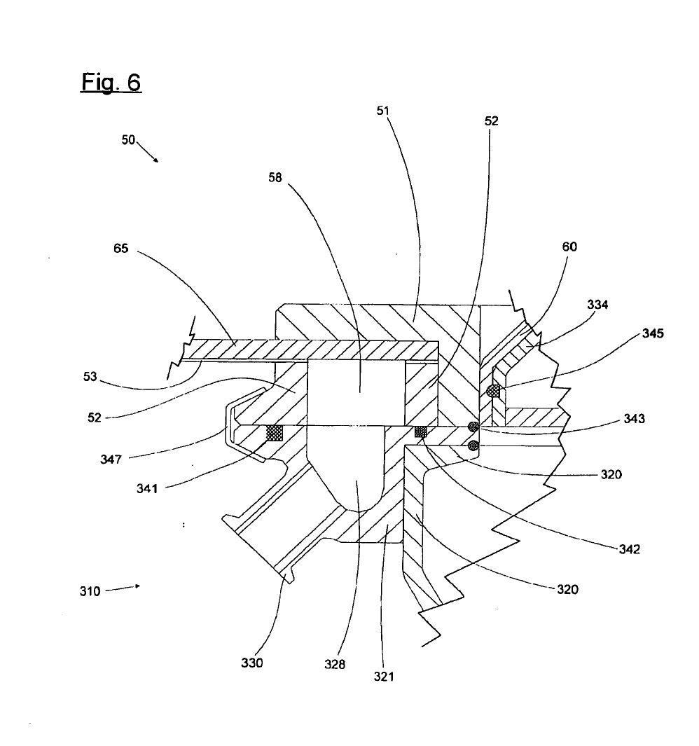

FIG. 6 shows an emptying device 310 to which the bulk goods container 50 of FIG. 1 already shown in FIG. 1 is connected. In the view of FIG. 6, the emptying device 310 and the bulk goods container 50 and/or the bag 50 are shown in a closed position.

The emptying device 310 shown in FIG. 6 differs from the emptying device 10 shown in FIG. 1, essentially merely relative to the configuration of the connection part, to which the connection flange 51, 52 of the bag 50 may be connected and/or is connected. Otherwise, the emptying device 310 shown in FIG. 6 is of substantially the same configuration as the emptying device 10 shown in FIG. 1.

The emptying device 310 shown in FIG. 6 in turn has a housing 320 provided with a through-flow channel. In contrast to the emptying device 10 shown in FIG. 1, however, the connection part of the emptying device 310 shown in FIG. 6 is not configured as the uppermost part of the housing 320. Instead, the connection part is configured as a component of a substantially annular component 321, of which the internal diameter corresponds to the internal diameter of the through-flow channel uppermost on the housing 320. The annular component 321 is part of an assembly which may be fitted to and/or is fitted to the housing 320. The annular component 321 is fitted to the uppermost part of the housing 320 by means of screws (not shown) fastened and/or fitted onto this housing 320.

In the upper face of the annular component 321 are configured an inlet discharging into the through-flow channel and an annular channel-shaped compressed air outlet 328 which in their shape and dimensions substantially correspond to the corresponding inlet 26 and/or the corresponding compressed air outlet 28 of the emptying device 10 shown in FIG. 1. Furthermore, the annular component 321 is provided with a compressed air connection 330, which comprises a through-passage discharging from obliquely below into the compressed air outlet 328, through which compressed air may be supplied into the compressed air outlet 328.

In the state shown in FIG. 6, the connection flange 51, 52 of the bag 50 is clamped by means of an annular retaining clip 347 to the connection part and/or the component 321 and/or the emptying device 10. In this state, three sealing rings 341, 342, 343 are arranged between the surfaces of the connection flange 51, 52 in contact with one another and the component 321 in order to seal the compressed air outlet 328 and/or the through-flow channel in the transition region between the connection flange 51, 52 and the annular component 321.

The emptying device 310 shown in FIG. 6, in turn, comprises a closure actuating device provided with a conical closure actuating element 334. On the outer side of the closure actuating element 334, a driving ring 345 is attached which serves to create a non-positive connection between the closure actuating element 334 and the closure body 60 resting on the closure actuating element 334 and to drive the latter by means of frictional force.

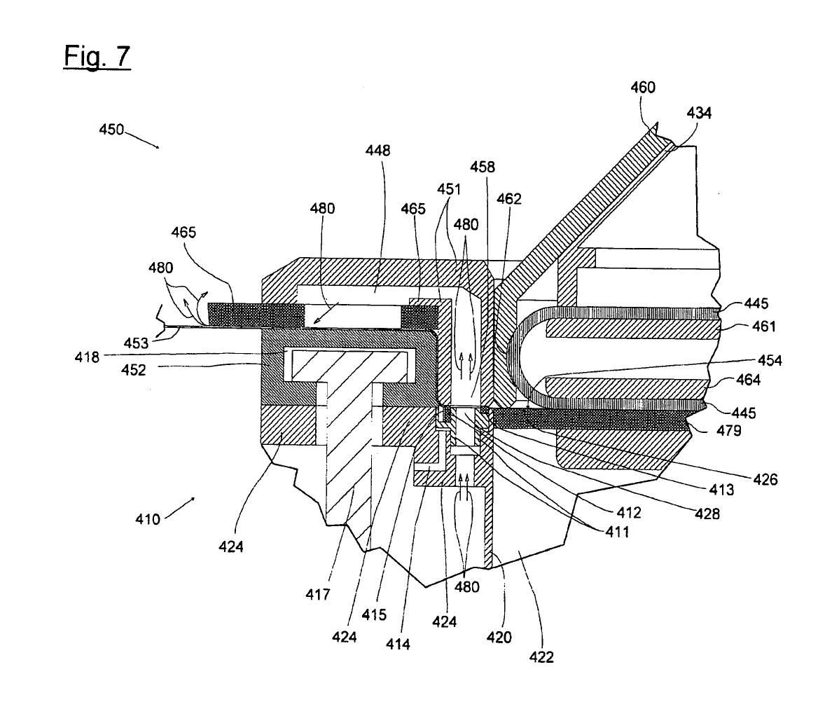

FIG. 7 shows an emptying device 410, to which a bulk goods container 450 is connected. The emptying device 410 comprises a housing 420 in which a through-flow channel 422 is configured. The housing 420 has a substantially planar, circular upper face arranged horizontally, in which a circular aperture 426 is configured which serves as an inlet 426 for bulk goods flowing into the through-flow channel 422 (not shown). The inlet 426 discharges into a first (upper) end of the through-flow channel 422.

The bulk goods container 450 is a bag 450 with a flexible container wall 453 and/or bag wall 453, which has the shape of a case which is closed on all sides as far as the closure described hereinafter. A closure is inserted in the lowest region of the bag wall 453 forming the base of the bag 450. The closure has a connection flange 451, 452, a closure body 460 and a shut-off body 465 configured as a non-return sealing lip.

The uppermost part of the housing 420 is configured as a connection part 424 of the emptying device 410. In the upper face of the connection part 424 upwardly open through-passages 428 are configured, which serve as compressed air outlets 428 of the emptying device 410. The through-passages 428 extend substantially in a horizontal plane along the outer periphery of the inlet 426 and completely enclose said inlet. The through-passages 428 are further provided with a compressed air connection (not shown), through which compressed air may be supplied into the through-passages 428. The arrows 480 in FIG. 7 indicate the compressed air flow 480.

The emptying device 410 is further provided with a closure actuating device for selectively opening and closing a closure of the bulk goods container 450. The closure actuating device comprises a closure actuating element 434 and an adjustment device (not shown) mounted on the housing 420, by means of which the closure actuating element 434 may be displaced selectively in the vertical direction relative to the housing 420 and the connection part 424. The adjustment device is of similar configuration to the adjustment device 236 of the emptying device 210 shown in FIG. 3. In contrast to the adjustment device 236 of the emptying device 210 shown in FIG. 3, however, the adjustment device of the emptying device 410 shown in FIG. 7 is configured such that it allows a greater lift for displacing the closure actuating element 434. By means of the adjustment device of the emptying device 410 shown in FIG. 7, the closure actuating element 434 may also be displaced, in particular, into a position in which the entire closure actuating element 434 is completely arranged below the planar upper face of the housing 420, configured as a connection part 424. To this end, the piston-cylinder arrangement of the adjustment device of the emptying device 410 shown in FIG. 7 in comparison with the piston-cylinder arrangement 270, 277, 278 of the adjustment device 236 of the emptying device 210 shown in FIG. 7 comprise one or more additional hollow cylinders.

The closure actuating element 434 comprises a substantially conical body made from a rigid material with a base plate 461. On this base plate 461 is attached a driving unit 445. The driving unit 445 is configured as a three-dimensional hollow body 445 which is sealed in an airtight manner and filled with air and which substantially has the shape of a comparatively planar circular cylinder and is made from a flexible airtight material. In the region of the cover surface, the cylindrical driving unit 445 is rigidly connected to the base plate 461 of the conical body of the closure actuating element 434. In the region of the base or bottom surface, the driving unit 445 is rigidly connected to a pressure plate 464, which may be selectively adjusted by means of a pneumatic drive (not shown) relative to the base plate 461 in the vertical direction. By means of an adjustment of the pressure plate 464 relative to the base plate 461 the driving unit 445 may therefore be selectively compressed or expanded in the vertical direction. As a result, the outer periphery of the driving unit 445 may be selectively enlarged or reduced. Due to the flexible material from which the driving unit 445 is made, when the driving unit 445 is compressed in the vertical direction its periphery is enlarged in a horizontal plane, as on the one hand the air pressure in the driving unit 445 increases and on the other hand the outer casing of the substantially cylindrical driving unit 445 is curved outwardly and transversely to the compression direction. Conversely, when the driving unit 445 is expanded in the vertical direction its periphery is reduced in the horizontal.

The closure body 460 is configured and arranged for selectively closing and opening the outlet 454. It is made from a rigid plastics material and configured as a hollow body, which has a circular cylindrical shell-shaped lower part and a conical upper part. The conical shape of the inner space of the closure body 460 substantially corresponds to the outer shape of the conical body of the closure actuating element 434.

In the inner face of the circular cylindrical shell-shaped lower part of the closure body 460, a peripheral groove 462 is configured in a horizontal plane. This serves as a driving stop 462 which cooperates with the driving unit 445. In the view of FIG. 7 the bulk goods container 450 is connected to the connection part 424 of the emptying device 410. The driving unit 445 of the closure actuating element is arranged in the inside of the circular cylindrical shell-shaped lower part of the closure body 460 such that it engages in the groove 462 with an enlarged outer periphery as shown in FIG. 7. When in this state, the closure actuating element 434 is displaced by means of the adjustment device, then the closure body 460 is driven by the closure actuating element 434 as the driving unit 445 engages in the groove 462. At the same time, the driving unit also serves as a selectively repeatedly releasable clamping seal which seals the intermediate space between the body 460 and the closure actuating element 434.

When the spacing is increased in the vertical direction between the base plate 461 and the pressure plate 464, the driving unit 445 is thus expanded and its periphery reduced such that it no longer engages in the groove 462 (not shown). With a vertical displacement of the closure actuating element 434 downwards, said closure actuating element no longer drives the closure body 460.

The connection flange 451, 452 is made up of an inner flange part 451 and an outer flange part 452, which are both of circular configuration and arranged concentrically to one another. The two flange parts 451, 452 are made from a rigid plastics material. The inner flange part 451 has a circular cylindrical shell-shaped part which has the shape of a tubular portion and laterally defines a circular cylindrical through-passage extending substantially vertically which serves as an outlet 454 for bulk goods received in the bag 450. The outer flange part 452 has the shape of a thick annular disc with a central through-passage. In the view of FIG. 7 the cylindrical shell-shaped part of the inner flange part 451 is inserted from above into the central through-passage in the outer flange part 452, so that the two flange parts 451, 452 are rigidly connected to one another by means of an interference fit. Between the inner flange part 451 and the outer flange part 452, the bag wall 453 is clamped such that it is merely connected to the connection flange 451, 452 by the clamping force.

A groove with a T-shaped cross-section 418 is configured along the outer periphery of the outer flange part 452 in the lower face of the outer flange part 452, and which is shown in cross-section in FIG. 7. This T-shaped groove 418 serves as a locking receiver 418 which cooperates with T-shaped locking bolts 417, which are arranged along the outer periphery of the connection part 424 in the upper face thereof, such that they project upwardly therefrom. In FIG. 7 a locking bolt 417 is shown in cross-section.

The T-shaped locking bolt 417 is connected in a tension-proof manner to the connection part 424 and may be selectively pivoted to and fro about the bolt axis by means of a pneumatic drive. In the view of FIG. 7, the bulk goods container 450 is connected to the emptying device 410. In this state, the outer flange part 452 is arranged in the vertical direction abutting the connection part 424. The locking bolt 417 is received in the T-shaped groove 418 and rotated about the bolt axis such that, with the bolt head, it laterally engages two retaining edges of the T-shaped groove 418. As a result, a positive connection is created in the vertical direction between the connection part 424 and the outer flange part 452.

In order to be able to release the bulk goods container 450 from the emptying station 410, the locking bolt 417 is rotated about the bolt axis by means of the pneumatic drive such that it no longer engages the retaining edges of the T-shaped groove 418 with its bolt head. Subsequently, the connection flange 451, 452 is able to be lifted upwardly from the connection part 424.

In the lower face of the inner flange part 451, a plurality of circular openings 458 are configured which discharge into channels 448 which are also completely configured in the inner flange part 451 and firstly lead upwardly and then outwardly in the radial direction. In FIG. 7 an opening 458 and a channel 448 are shown in cross-section. The opening 458 serves as a compressed air inlet 458. In the state shown in FIG. 7, in which the bulk goods container 450 is connected to the emptying station 410, the compressed air inlet 458 cooperates with the through-passage 428 serving as a compressed air outlet such that compressed air is able to flow from the compressed air outlet 428 through the compressed air inlet 458 and the channel 448, through a through-passage in the shut-off body 465 and along its lower face, into the bag 450. The compressed air flow 480 and/or its flow direction is shown in FIG. 7 by the arrows 480.

In the state shown in FIG. 7, a circular hole is cut out of the bag wall 453 by means of the round blade 415 described below. Inside the region surrounded by this hole, are arranged the outlet 454 and the compressed air inlet 458 of the connection flange 451, 452. The compressed air therefore flows from the compressed air inlet 458 through the hole, past the edge of the hole and into the inside of the bulk goods container.

The connection part 424 of the emptying device 410 is further provided with a blade unit which is substantially arranged in an annular channel. The blade unit comprises an annular base part 411, which is displaceably arranged in the annular channel in the vertical direction and bears a round blade 415 projecting upwardly. The base part is provided with piston parts projecting laterally out of the annular channel which, by means of compressed air, which is supplied through a compressed air channel 414 configured in the connection part 424, are pneumatically displaceable in the vertical direction and thus form a pneumatic drive for adjusting the blade unit in the vertical direction.

Before the bulk goods container shown in FIG. 7 is connected to the emptying device 410, the lower face of the inner flange part 451 is completely covered by the bag wall 453. In this state (not shown) the bag wall 453 is completely intact in the region of the connection flange 451, 452 and completely intact in its periphery and comprises no perforation or through-passage here. In the part of the bag wall 453 which covers the inner flange part 451, a covering member is formed in this state, which covers the outlet 454 and which is configured as an integral part of the bag wall 453.

If the bulk goods container 450 is now connected with its connection flange 451, 452 to the connection part 424 of the emptying device 410, firstly the closure actuating element 434 is displaced to such an extent downwards that the entire closure actuating element 434 (i.e. also its tip) is located below the planar upper face of the connection part 424. Then the connection flange 451, 452 is arranged on the upper face of the connection part 424 and automatically locked by means of the locking bolt 417 to the connection part 424. Next, the blade unit with the round blade 415 is displaced upwardly such that the round blade 415 cuts out that part of the bag wall 453 which covers the inner flange part 451 below. The round blade 415 is then left in a position substantially flush with the upper face of the connection part 424, two annular seals 412, 413 arranged laterally on the upper face of the round blade unit sealing against the annular channel 428 and sealing the compressed air inlet 458 against the outside. Subsequently, the closure actuating element 434 is displaced upwardly and coupled to the closure body 460. In this connection, the part cut out from the bag wall 453 of the tip of the closure actuating element 434 is driven, so that, during the emptying process, this part is arranged between the closure actuating element 434 and the closure body 460, where it does not interrupt the emptying process.

A circular disc-shaped sealing element 479 is further arranged on the lower face of the driving unit 445. This sealing element 479 ensures, on the one hand, a seal between the closure actuating element 434 and the inner flange part 451 when the sealing element 479 is arranged in the region of the connection flange 451, 452. The sealing element 479 further serves as a stripper seal which cleans the inner flange part 451 or the through-flow channel 422 of bulk goods when the sealing element 479 is displaced through the inner flange part 415 and/or the through-flow channel 422. Additionally, the sealing element 479 serves for sealing the inlet 426 when it is arranged within said inlet. An additional covering element for covering the inlet 426 may then be dispensed with, even when the bulk goods container 450 is removed from the emptying device 410.

FIG. 8 shows a bulk goods container 550 configured as a bag 550 with a flexible bag wall 553 which has the shape of a case, which is closed on all sides as far as the closure described below. A closure is inserted in the lowest region of the bag wall 553 forming the base of the bag 550. The closure has a connection flange 551, 552, a closure body 560 and a shut-off body 565 configured as a non-return sealing lip. The bag 550 shown in FIG. 8 is of similar configuration to the bag 450 shown in FIG. 7 and differs therefrom, essentially merely relative to the configuration of the connection flange 551, 552 and the shut-off body 565.

The connection flange 551, 552 is made up of an inner flange part 551 and an outer flange part 552. The upper face 519 of the inner flange part is arranged in the inside of the bulk goods container 550 and forms a part of its base. This upper face 519 slopes in the direction towards the outlet 554 in order to assist the outflow of bulk goods. The angle of inclination of the upper face 519 relative to the horizontal is approximately 30°. As a whole, the inclined upper face 519 of the inner flange part 551 forms a substantially funnel-shaped slideway on which the bulk goods are able to slide in the direction of the outlet 554. The shapes of the compressed air inlets 557, 558 and the compressed air channels 548, 549 and the cross-sectional shape of the shut-off body 565 configured in the inner flange part 551 are adapted to the altered shape of the inner flange part 551.

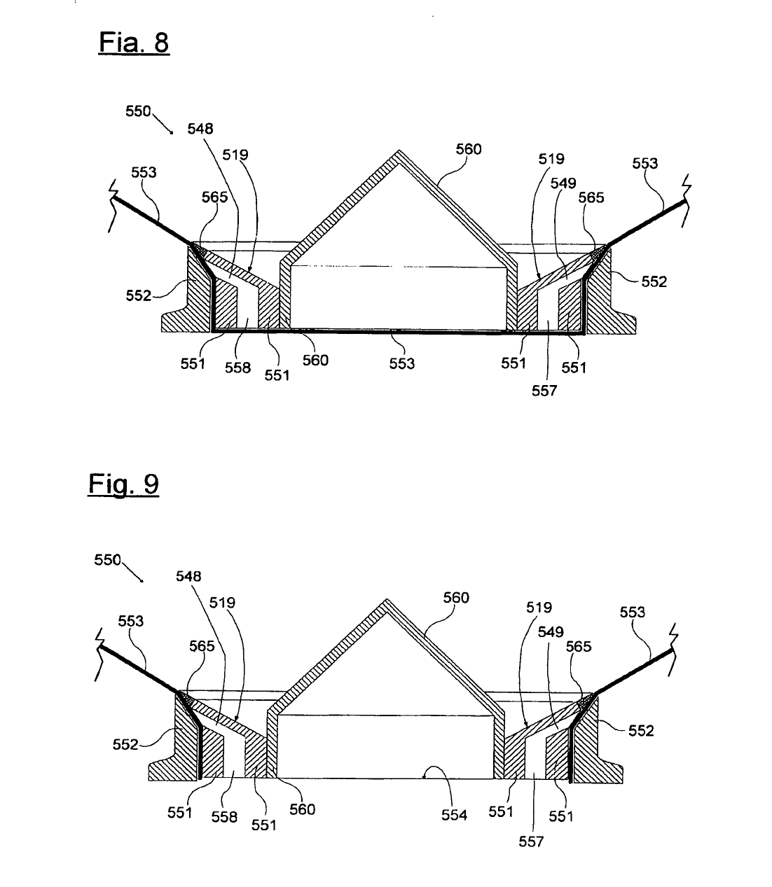

FIG. 8 shows the bag 550 before the connection to a corresponding emptying device (not shown). In this state, the entire lower face of the inner flange part 551 is covered by a covering member which is configured as an integral part of the bag wall 553. In FIG. 9 the bag 550 is shown in a state after the part of the bag wall 553 covering the inner flange part 551 below has been cut out by means of a round blade, which is configured in a similar manner to the round blade 415 of the emptying device 410 shown in FIG. 7.

In summary it is established that, by means of the invention, a bulk goods emptying device and a bulk goods container are provided which allow safe operation and reliable emptying of bulk goods from the bulk goods container.

1. An emptying device (10, 110, 210, 310, 410) for emptying bulk goods from a bulk goods container (50, 150, 250, 450, 550) which comprises a base structure (20, 120, 220, 320, 420), a connection part (24, 124, 224, 424) provided with an inlet (26, 126, 226, 426), a through-flow channel (22, 122, 222, 422) into which the inlet (26, 126, 226, 426) discharges, the connection part (24, 124, 224, 424) being configured for tightly joining a connection flange (51, 52, 151, 152, 251, 252, 451, 452, 551, 552) provided with an outlet (54, 154, 254, 454, 554) of a closure of the bulk goods container (50, 150, 250, 450, 550), and a closure actuating device (32, 34, 36, 132, 134, 136, 234, 236, 334, 434) mounted on the base structure (20, 120, 220, 320, 420) or on the connection part (24, 124, 224, 424) for actuating the closure of the bulk goods container (50, 150, 250, 450, 550), the closure actuating device (32, 34, 36, 132, 134, 136, 234, 236, 334, 434) being provided with a closure actuating element (34, 134, 234, 334, 434) and with an adjustment device (36, 136, 236) such that by means of the adjustment device (36, 136, 236) the closure actuating element (34, 134, 234, 334, 434) may be selectively displaced between a closed position and at least one open position, characterised in that the connection part (24, 124, 224, 424) is provided with a pneumatic gas outlet (28, 128, 228, 328, 428) separated from the inlet (26, 126, 226, 426) and which is configured for connecting a corresponding pneumatic gas inlet (57, 58, 458, 557, 558) of the connection flange (51, 52, 151, 152, 251, 252, 451, 452, 551, 552) to the pneumatic gas outlet (28, 128, 228, 328, 428) such that pneumatic gas is able to flow from the emptying device (10, 110, 210, 310, 410) through the pneumatic gas outlet (28, 128, 228, 328, 428) and the pneumatic gas inlet (57, 58, 458, 557, 558) into the bulk goods container (50, 150, 250, 450, 550) in order to loosen up bulk goods received in the bulk goods container (50, 150, 250, 450, 550).

2. The emptying device (310) according to claim 1, characterised in that the connection part provided with the pneumatic gas outlet (328) is configured as a component of an assembly (321) which may be fitted to the base structure (320) or is fitted to the base structure.

3. The emptying device (10, 110, 210, 310, 410) according to claim 1, characterised in that the connection part (24, 124, 224, 224) is configured as a first structural unit of a common coupling device for the connection both of the connection flange (51, 52, 151, 152, 251, 252, 451, 452, 551, 552) to the connection part (24, 124, 224, 424) and the pneumatic gas inlet (57, 58, 458, 557, 558) to the pneumatic gas outlet (28, 128, 228, 328, 428), the first structural unit being able to be coupled to a second structural unit of the coupling device formed by the connection flange (51, 52, 151, 152, 251, 252, 451, 452, 551, 552).

4. The emptying device (10, 110, 210, 310, 410) according to claim 3, characterised in that in an outer side of the connection part (24, 124, 224, 424) the inlet (26, 126, 226, 426) has an orifice with a planar edge and the pneumatic gas outlet (28, 128, 228, 328, 428) has in the same outer side of the connection part (24, 124, 224, 424) an orifice with a planar edge, the edge of the orifice of the inlet (26, 126, 226, 426) and the edge of the orifice of the pneumatic gas outlet (28, 128, 228, 328, 428) being arranged coplanar to one another.

5. The emptying device (10, 110, 210) according to one of claim 1, characterised in that the pneumatic gas outlet (28, 128, 228) in an outer side of the connection part (24, 124, 224) is configured as an at least partially outwardly open channel (28, 128, 228) which comprises at least one channel wall (29) which is also simultaneously configured as the channel wall (29) of the through-flow channel (22, 122, 222).

6. The bulk goods container (50, 150, 250, 450, 550) with a closure which has a connection flange (51, 52, 151, 152, 251, 252, 451, 452, 551, 552) provided with an outlet (54, 154, 254, 454, 554) for bulk goods received in the bulk goods container (50, 150, 250, 450, 550) and a closure member (60, 160, 260, 460, 560) for closing and selectively opening the outlet (54, 154, 254, 454, 554), the connection flange (51, 52, 151, 152, 251, 252, 451, 452) being configured for being tightly joined to a connection part (24, 124, 224, 424) of an emptying device (10, 110, 210, 310, 410) according to one of claims 1 to 5, characterised in that the connection flange (51, 52, 151, 152, 251, 252, 451, 452, 551, 552) is provided with a pneumatic gas inlet (57, 58, 458, 557, 558) separated from the outlet (54, 154, 254, 454, 554) and which is configured for being joined to a corresponding pneumatic gas outlet (28, 128, 228, 328, 428) of the connection part (24, 124, 224, 424) such that pneumatic gas is able to flow from the emptying device (10, 110, 210, 310, 410) through the pneumatic gas outlet (28, 128, 228, 328, 428) and the pneumatic gas inlet (57, 58, 458, 557, 558) into the bulk goods container (50, 150, 250, 450, 550) in order to loosen up the bulk goods.

7. The bulk goods container (50, 150, 250) according to claim 6, characterised in that the connection flange (51, 52, 151, 152, 251, 252, 451, 452, 551, 552) is configured as a second structural unit of a common coupling device for joining both the connection flange (51, 52, 151, 152, 251, 252, 451, 452, 551, 552) to the connection part (24, 124, 224, 424) and also the pneumatic gas inlet (57, 58, 458, 557, 558) to the pneumatic gas outlet (28, 128, 228, 328, 428), the second structural unit being able to be coupled to a first structural unit of the coupling device formed by the connection part (24, 124, 224, 424).

8. The bulk goods container (50, 150, 250, 450, 550) according to claim 7, characterised in that the outlet (54, 154, 254, 454, 554) has in an outer side of the connection flange (51, 52, 151, 152, 251, 451, 452, 551, 552) an orifice with a planar edge and the pneumatic gas inlet (57, 58, 458, 557, 558) in the same outer side of the connection flange (51, 52, 151, 152, 251, 252, 451, 452, 551, 552) has an orifice with a planar edge, the edge of the orifice of the outlet (54, 154, 254, 454, 554) and the edge of the orifice of the pneumatic gas inlet (57, 58, 458, 557, 558) being arranged coplanar to one another.

9. The bulk goods container (50, 150, 250, 450, 550) according to claim 6, characterised in that the pneumatic gas inlet (57, 58, 458, 557, 558) is sealed by a non-return valve towards the interior of the bulk goods container (50, 150, 250, 450, 550) and which allows the flow of fluid through the pneumatic gas inlet (57, 58, 458, 557, 558) in the direction of the bulk goods container interior, but prevents a flow of fluid in the opposite direction from the bulk goods container interior through the pneumatic gas inlet (57, 58, 458, 557, 558).

10. The bulk goods container (50, 150, 250, 450, 550) according to claim 9, characterised in that the non-return valve comprises a shut-off body (65, 165, 265, 465, 565) made from a resilient material which simultaneously also acts as a return spring (65, 165, 265, 465, 565) of the non-return valve.

11. The bulk goods container (50, 150, 250) according to claim 10, characterised in that the shut-off body (65, 165, 265) is configured and at least partially arranged in the interior of the bulk goods container (50, 150, 250) such that it may be stimulated to oscillate by means of pneumatic gas which flows through the pneumatic gas inlet (57, 58) into the interior of the bulk goods container (50, 150, 250), in order to loosen up further the bulk goods.

12. The bulk goods container (50, 150, 250, 450, 550) according to claim 6, characterised in that a substantial portion of the container wall (53, 153, 253, 453, 553) is made from a flexible material whilst the connection flange (51, 52, 151, 152, 251, 252, 451, 452, 551, 552) is made from a rigid material, at least one first through-passage of the outlet (54, 154, 254, 454, 554) and also at least one further through-passage of the pneumatic gas inlet (57, 58, 458, 557, 558) being configured in the connection flange (51, 52, 151, 152, 251, 252, 451, 452, 551, 552).

13. The bulk goods container (450, 550) according to claim 12, characterised in that the flexible part of the container wall (453, 553) is provided with a hole of which the edge forms a closed periphery, the container wall (453, 553) being connected to the connection flange (451, 452, 551, 552) along the edge of the hole and the outlet (454, 554) configured in the connection flange (451, 452, 551, 552) being arranged in the region of the hole and a channel (448, 449, 549) leading from the pneumatic gas inlet (458, 557, 558) into the container interior being configured in the connection flange (451, 551) such that it leads from the pneumatic gas inlet (458, 557, 558) through the hole, past the edge of the hole into the interior of the bulk goods container (450, 550).

14. The assembly (321) for fitting an emptying device (310) to a base structure (320) according to claim 2.

15. The emptying device (210) in particular according to claim 1 for emptying bulk goods from a bulk goods container (250) which comprises a base structure (220), a connection part (224) provided with an inlet (226), a through-flow channel (222) into which the inlet discharges (226), the connection part (224) being configured for tightly joining a connection flange (251, 252), provided with an outlet (254), of a closure of the bulk goods container (250) and a closure actuating device (234, 236) mounted on the base structure (220) or on the connection part (224) for actuating the closure of the bulk goods container (250), the closure actuating device (234, 236) being provided with a closure actuating element (234) and with an adjustment device (236) such that by means of the adjustment device (236) the closure actuating element (243) may be selectively displaced between a closed position and at least one open position, characterised in that the adjustment device (236) comprises a piston-cylinder arrangement with a piston (270) mounted on the base structure (220) or on the connection part (224) and at least one cylinder (277), in which the piston (270) is received such that the cylinder (270) may be displaced relative to the piston (270) in the direction of the cylinder axis, the cylinder (270) being coupled to the closure actuating element (234) and said closure actuating element being coupled to a closure member (260) of the closure when the bulk goods container (250) is connected to the connection part (224) of the emptying device (210), in order to effect an actuation of the closure member (260) driven by the piston-cylinder arrangement.

16. The emptying device (410) in particular according to claim 1 for emptying bulk goods from a bulk goods container (450, 550) which comprises a base structure (420), a connection part (424) provided with an inlet (426) and a through-flow channel (422), into which the inlet (426) discharges, the connection part (424) being configured for tightly joining a connection flange (451, 452, 551, 552), provided with an outlet (454, 554), of a closure of the bulk goods container (450, 550) and a closure actuating device (434) mounted on the base structure (420) or on the connection part (424) for actuating the closure of the bulk goods container (450, 550), characterised in that the connection part (424) is further provided with a blade unit (411) which is configured to cut off a covering member (553) which, when the bulk goods container (450, 550) is not connected to the emptying device (410), is arranged on the connection flange (451, 452, 551, 552) such that it covers the outlet (454, 554) on the outer side of the bulk goods container (450, 550).

17. The bulk goods container (450, 550) in particular according to claim 6, with a closure which has a connection flange (451, 452, 551, 552) provided with an outlet (454, 554) for bulk goods received in the bulk goods container (450, 550) and a closure member (460, 560) for closing and selectively opening the outlet (454, 554), the connection flange (451, 452, 551, 552) being configured for tightly joining an emptying device (410) to a connection part (424) according to claim 16, characterised in that a substantial portion of the container wall (453, 553) is made from a single-layered or multi-layered flexible material, whilst the connection flange (451, 452, 551, 552) is made from a rigid material, at least one first through-passage of the outlet (454, 554) being configured in the connection flange (451, 452, 551, 552) and the closure further comprising a covering member which, when the bulk goods container (450, 550) is not connected to the emptying device, is arranged on the connection flange (451, 452, 551, 552) such that it covers the outlet (454, 554) on the outer side of the bulk goods container (450, 550), the covering member being configured as an integral part of the portion of the container wall (453, 553) made from flexible material.

18. The emptying device (410) in particular according to claim 1 for emptying bulk goods from a bulk goods container (450) which comprises a base structure (420), a connection part (424) provided with an inlet (426), a through-flow channel (422) into which the inlet (426) discharges, the connection part (424) being configured for tightly joining a connection flange (451, 452), provided with an outlet (454), of a closure of the bulk goods container (450) and a closure actuating device mounted on the base structure (420) or on the connection part (424) for actuating the closure of the bulk goods container (450), the closure actuating device being provided with a closure actuating element (434) and with an adjustment device such that by means of the adjustment device the closure actuating element (434) may be selectively displaced between a closed position and at least one open position, the closure actuating element (434) being coupled, when the bulk goods container (450) is connected to the connection part (424) of the emptying device (410), to a closure member (460) of the closure, in order to effect an actuation of the closure member (460) by means of the closure actuating device, characterised in that for the selectively repeatedly releasable coupling of the closure actuating element (434) to the closure member (460), the closure actuating element (434) is provided with a driving unit (445) of which the outer periphery may be selectively altered.

19. The bulk goods container (450) in particular according to claim 6, with a closure which has a connection flange (451, 452) provided with an outlet (454) for bulk goods received in the bulk goods container (450) and a closure member (460) for closing and selectively opening the outlet (454), the connection flange (451, 452) being configured for tightly joining an emptying device (410) to a connection part (424) according to claim 18, characterised in that the closure member (460) is provided with a driving stop (462) which is configured and arranged on the closure member (460) such that when the bulk goods container (450) is connected to the connection part (424) of the emptying device (410) the driving unit (445), depending on its periphery, either drives or does not drive the driving stop (462) together with the closure member (460), when the closure actuating element (434) is displaced by means of the adjustment device.

20. The emptying device (410) in particular according to claim 1 for emptying bulk goods from a bulk goods container (450), which comprises a base structure (420), a connection part (424) provided with an inlet (426), a through-flow channel (422) into which the inlet discharges (426), the connection part (424) being configured for tightly joining a connection part (451, 452), provided with an outlet (454), of a closure of the bulk goods container (450) and a closure actuating device (434) mounted on the base structure (420) or on the connection part (424) for actuating the closure of the bulk goods container (450), characterised in that the connection part (424) is provided with at least one locking element (417) which is connected in a tension-proof manner to the connection part (424) and configured such that—when the bulk goods container (450) is arranged relative to the emptying device (410) such that the connection flange (451, 452) impacts in an impact direction against the connection part (424)—the locking element (417) may be received in a locking receiver (418) connected in a tension-proof manner to the connection flange (451, 452), such that a positive connection acting in a tension-proof manner counter to the direction of impact, is created between the connection part (424) and the connection flange (451, 452).

21. The bulk goods container (450) in particular according to claim 6, with a closure which has a connection flange (451, 452) provided with an outlet (454) for bulk goods received in the bulk goods container (450) and a closure member (460) for closing and selectively opening the outlet (454), the connection flange (451, 452) being configured for tightly joining an emptying device (410) to a connection part (424) according to claim 20, characterised in that the connection flange (451, 452) is provided with at least one locking receiver (418), which is connected in a tension-proof manner to the connection flange (451, 452) and is configured such that—when the bulk goods container (450) is arranged relative to the emptying device (410) such that the connection flange (451, 452) impacts in an impact direction against the connection part (424)—the locking element (417) may be received in the locking receiver, such that a positive connection acting in a tension-proof manner counter to the direction of impact is created between the connection part (424) and the connection flange (451, 452).

22. The emptying device (10, 210, 310) in particular according to claim 1 for emptying bulk goods from a bulk goods container (50, 250) which comprises a base structure, a connection part (24, 224) provided with an inlet (26, 226) and a through-flow channel (24, 224) into which the inlet (26, 226) discharges, the connection part (24, 224) being configured for tightly joining a connection flange (51, 52, 251, 252), provided with an outlet (54, 254), of a closure of the bulk goods container (50, 250) and a closure actuating device (32, 34, 36, 234, 237, 267, 334) mounted on the base structure (20, 220, 320) or on the connection part (24, 224) for actuating the closure of the bulk goods container (50, 250), characterised in that the closure actuating device (32, 34, 334, 36, 234, 236, 237, 267) comprises a rotary drive (36, 237) which may be coupled to a closure body (60, 260) of the closure such that in the coupled state the closure body (60, 260) may be rotated by means of the rotary drive (36, 237) about a first rotational axis which is stationary relative to the connection part (24, 224).

23. The emptying device (10) according to claim 22, characterised in that the closure actuating device (32, 34, 36, 234, 236, 237, 267, 334) further comprises a closure actuating element (34, 234) which may be coupled to the closure body (60, 260), an elongate drive shaft (32, 267) fixedly connected to the closure actuating element (34, 234, 334) which is arranged coaxially with the first rotational axis, and an adjustment device (36, 236, 237) which is configured and arranged such that by means of the adjustment device (36, 236, 237) the drive shaft (32, 267) may be selectively displaced together with the closure actuating element (34, 234, 334) between a closed position and at least one open position substantially parallel to the first rotational axis, the rotary drive (36, 237) being coupled to the drive shaft (32, 267) such that the drive shaft (32, 267) may be rotated about the first rotational axis by means of the rotary drive (36, 237) relative to the connection part (24, 224).

24. The emptying device (10) according to claim 23, characterised in that at least one chopping element (31, 33, 35, 37) projecting in the radial direction from the drive shaft is attached fixedly in terms of rotation to the drive shaft (32).

25. The emptying device according to claim 23, characterised in that one or more bulk goods conveying elements are attached fixedly in terms of rotation to the drive shaft, such that they convey bulk goods along the drive shaft in the manner of a conveyor worm or in the manner of turbine when the drive shaft rotates about the first rotational axis.

26. The bulk goods container (50, 250) in particular according to claim 6, with a closure which has a connection flange (51, 52, 251, 252) provided with an outlet (54, 254) for bulk goods received in the bulk goods container (50, 250) and a closure body (60, 260) for closing and selectively opening the outlet (54, 254), the connection flange (51, 52, 251, 252) being configured for tightly joining an emptying device (10, 210, 310) to a connection part (24, 224) according to one of claims 22 to 25 and the closure body (60, 260) being substantially arranged in an interior of the bulk goods container (50, 250) provided for receiving the bulk goods, characterised in that the closure body (60, 260) may be rotated about a second rotational axis relative to the connection flange (51, 52, 251, 252) and in that the closure body (60, 260) is able to be coupled to a rotary drive (36, 237) which is mounted on a base structure (20, 220) or on the connection part (24, 224) of the emptying device (10, 210), such that in the coupled state the closure body (60, 260) may be rotated about the second rotational axis by means of the rotary drive (36, 237).

27. The bulk goods container according to claim 26, characterised in that at least one loosening element is attached fixedly in terms of rotation to the closure body and which projects at least partially into the interior of the bulk goods container.

28. The bulk goods container according to claim 26, characterised in that one or more bulk goods conveying elements are attached fixedly in terms of rotation to the closure body such that when the closure body rotates about the second rotational axis, they convey bulk goods in the manner of a conveyor worm or in the manner of a turbine in the direction of the outlet.

29. The emptying device (10, 110, 210, 310) in particular according to claim 1 for emptying bulk goods from a bulk goods container (50, 150, 250) which comprises a connection part (24, 124, 224) provided with an inlet (26, 126, 226) and a through-flow channel (22, 122, 222) into which the inlet (26, 126, 226) discharges, the connection part (24, 124, 224) being configured for tightly joining a connection flange (51, 52, 151, 152, 251, 252), provided with an outlet (54, 154, 254), of a closure of the bulk goods container (50, 150, 250), characterised in that the emptying device (10, 110, 210, 310) has at least one emptying device-contact part (24, 34, 124, 134, 224, 234, 334) which, when the connection flange (51, 52, 151, 152, 251, 252) of the bulk goods container (50, 150, 250) is connected to the connection part (24, 124, 224), is in contact with a bulk goods container-contact part (51, 52, 151, 152, 251, 252, 60, 260) of the bulk goods container (50, 150, 250), the emptying device-contact part (24, 34, 124, 134, 224, 234, 334) being at least partially made from and earthed by an electrically conductive material.

30. The emptying device (10, 110, 210, 310) according to claim 29, characterised in that the connection part (24, 124, 224) is configured simultaneously as an emptying device-contact part (24, 34, 124, 134, 224, 234, 334).

31. The emptying device (10, 110, 210, 310) according to claim 29, characterised in that it further comprises a base structure (20, 120, 220, 320) and a closure actuating device (32, 34, 36, 132, 134, 136, 234, 236, 334) mounted on the base structure (20, 120, 220) or on the connection part (24, 124, 224) for actuating the closure of the bulk goods container (50, 150, 250), the closure actuating device (32, 34, 36, 132, 134, 136, 234, 236, 334) being provided with a closure actuating element (34, 134, 234, 334) and with an adjustment device (36, 136, 236) such that by means of the adjustment device (36, 136, 236) the closure actuating element (34, 134, 234, 334) may be selectively displaced between a closed position and at least one open position, the closure actuating element (34, 134, 234, 334) being simultaneously configured as the emptying device-contact part (24, 34, 124, 134, 224, 234, 334).

32. The bulk goods container (50, 150, 250) in particular according to claim 6 with a closure which has a connection flange (51, 52, 151, 152, 251, 252) provided with an outlet (54, 154, 254) for bulk goods received in the bulk goods container (50, 150, 250) and a closure member (60, 160, 260) for closing and selectively opening the outlet (54, 154, 254), the connection flange (51, 52, 151, 152, 251, 252) being configured for tightly joining an emptying device (10, 110, 210, 310) to a connection part (24, 124, 224) according to one of claims 29 to 31, characterised in that the bulk goods container (50, 150, 250) has at least one bulk goods container-contact part (51, 52, 151, 152, 251, 252, 60, 260) which is made at least partially from an electrically conductive material and, when the connection flange (51, 52, 151, 152, 251, 252) is connected to the connection part (24, 124, 224), is in contact with an emptying device-contact part (24, 34, 124, 134, 224, 234, 334) of the emptying device (10, 110, 210, 310) and is electrically conductively connected to the emptying device-contact part (24, 34, 124, 134, 224, 234, 334).

33. The bulk goods container (50, 150, 250) according to claim 32, characterised in that the connection flange (51, 52, 151, 152, 251, 252) is simultaneously configured as a bulk goods container-contact part (51, 52, 151, 152, 251, 252, 60, 260).

34. The bulk goods container (50, 250) according to claim 32, characterised in that the closure member (60, 260) is simultaneously configured as a bulk goods container-contact part (24, 34, 124, 134, 224, 234, 334).

35. The bulk goods container (250) in particular according to claim 6, with a closure which has a connection flange (251, 252) with an outlet (254) for bulk goods received in the bulk goods container (250) and a closure body (260) for closing and selectively opening the outlet (254), the connection flange (251, 252) being configured for tightly joining an emptying device (210) to a connection part (254) according to one of claims 1 to 5 or 15 to 16 or 18 or 20 or 22 to 25 or 29 to 31, and the closure body (260) being substantially arranged in an interior of the bulk goods container (250) provided for receiving the bulk goods and comprising a hollow space which is open towards the outlet (254), characterised in that the closure further comprises a covering member (281, 282) which may be attached to the connection flange (251, 252) when the bulk goods container (250) is not connected to the emptying device (210), such that it covers the outlet (254) on the outer side of the bulk goods container (250), the covering member (281, 282) being configured and being arranged at least partially projecting through the outlet (254) into the hollow space of the closure body (260), such that it has, in turn, an outwardly open hollow space, in which a closure body (360) of an identical bulk goods container (350) may be partially received.

36. The bulk goods container (250) according to claim 35, characterised in that the covering member (281) is connected to the closure body (260) when attached to the connection flange (251, 252).

37. The bulk goods container (550) in particular according to claim 6, with a closure which has a connection flange (551, 552) provided with an outlet (554) for bulk goods received in the bulk goods container (550) and a closure body (560) for closing and selectively opening the outlet (554), the connection flange (551, 552) being configured for tightly joining an emptying device (10, 110, 210, 310, 410) to a connection part (554) according to one of claims 1 to 5 or 15 to 16 or 18 or 20 or 22 to 25 or 29 to 31, characterised in that at least one surface part (519) of the connection flange (551, 552) is configured and arranged such that in the interior of the bulk goods container (550) it forms a part of the base thereof and slopes in the outlet (554) in order to assist the outflow of bulk goods.

38. The closure for a bulk goods container (50, 150, 250, 450, 550) according to claim 6.

39. The closure according to claim 38, characterised in that it is configured as an exchangeable unit for multiple use for different bulk goods containers (450, 550) which are configured identically or differently.
